(19) United States
(12) Patent Application Publication
(10) Pub. No.: US 2023/0340677 A1
(43) Pub. Date: Oct. 26, 2023

(54) DEVICE AND METHODS FOR PRODUCTION OF AMMONIA AND NITRATES UNDER AMBIENT CONDITIONS

(71) Applicant: THE BOARD OF TRUSTEES OF THE UNIVERSITY OF ILLINOIS, Urbana, IL (US)

(72) Inventors: Nishithan C. Kani, Chicago, IL (US); Aditya Prajapati, Chicago, IL (US); Meenesh R. Singh, Naperville, IL (US)

(21) Appl. No.: 18/026,611

(22) PCT Filed: Sep. 16, 2021
(86) PCT No.: PCT/US2021/050573

§ 371 Date: Mar. 16, 2023

Related U.S. Application Data
(60) Provisional application No. 63/079,415, filed on Sep. 16, 2020.

(51) Int. Cl. C25B 1/27; C25B 9/70; C25B 11/031; C25B 11/075; C25B 9/19; C25B 11/052; C25B 11/065

(52) U.S. Cl. CPC C25B 1/27; C25B 9/19; C25B 9/70; C25B 11/031; C25B 11/052; C25B 11/065; C25B 11/075; C02F 1/4676

(57) ABSTRACT

The disclosure relates to units, systems and methods for producing ammonia from a nitrogen-containing feedstock from sources like wastewater, ammonium nitrate solution, or an input gas containing one or more nitrogen-containing species, which can advantageously reduce carbon dioxide emissions, and energy consumption, as well as balance the nitrogen cycle.

### CROSS-REFERENCE TO RELATED APPLICATIONS

This application claims the benefit of priority to U.S. Provisional Pat. Application No. 63/079,415 filed Sep. 16, 2020, the disclosure of which is incorporated herein by reference in its entirety.

### BACKGROUND

### Field of the Disclosure

The disclosure relates to systems and methods for producing ammonia from a nitrogen-containing feedstock from sources like wastewater, ammonium nitrate solution (ANSOL) waste stream from production of energetic materials, or an input gas containing one or more nitrogen-containing species, which can advantageously reduce carbon dioxide emissions, and energy consumption, as well as balance the nitrogen cycle.

### Brief Description of Related Technology

Ammonia (NH₃) is an important commodity chemical for the manufacturing of numerous materials including, for example, fertilizers, pharmaceuticals, plastics, and ammunition. It is produced at a massive rate of 200 mega-metric tons per year globally with a 60 billion USD market value. Ammonia is also used as a potential energy carrier due to its higher energy density of 4.3 kWh/kg and H₂ content of 17.75 wt.% (40 % higher than methanol). Such a high demand for NH₃ is met primarily by an industrial-scale Haber-Bosch process, which has a severe environmental impact. The Haber-Bosch process requires high temperatures (e.g., 450-500° C.) and high pressures (e.g., 200 bar), resulting in energy consumption of approximately 2.6 exajoules per year and higher capital cost due to the centralized production. The net carbon dioxide (CO₂) emissions of 420 million tons of CO₂ equivalent per year makes this a top chemical product responsible for greenhouse gas emission.

Electrochemical synthesis of NH₃ can provide a sustainable alternative to the conventional Haber-Bosch process if activated at ambient conditions using electrical energy derived from renewable sources (e.g., solar and wind energy). Ammonia can be synthesized electrochemically at ambient conditions using a variety of nitrogen precursors such as N₂, NO₃⁻, NO₂⁻, and NOₓ and H₂O as a hydrogen source. While oxides of nitrogen can be sourced from waste or pollutant streams, it would be ideal if the entire process could be conducted carbon-free by utilizing N₂ from the air, H₂O, earth-abundant electrocatalyst, and energy from renewable sources. However, direct electrochemical reduction of N₂ to NH₃ is a challenging pursuit due to the high energy of N≡N triple bond (941 kJ/mol), dominant undesired H₂ evolution reaction (HER), and lower solubility of N₂ in aqueous solution. The highest reported Faradaic efficiency (FE) for electrochemical N₂ to NH₃ is 66% with a partial current density of about 1 mA/cm² on Bi nanocrystals, which has been difficult to reproduce. Due to the lower activity of direct N₂ reduction, indirect approaches including two-step N₂ reduction such as lithium-mediated NH₃ synthesis and NO₃⁻ meditated NH₃ synthesis have been evaluated. To date, regardless of the choice of a nitrogen precursor, the NH₃ current density and FE are far too small to have industrial applicability. For example, a lithium-mediated approach has been reported to increase the NH₃ current density to 8.8 mA/cm² while keeping the FE to 30%.

### SUMMARY

The electrochemical reduction of dinitrogen (N₂) and H₂O to ammonia (NH₃) is of exceptional scientific, societal, and industrial importance. Such a route to produce NH₃ can effectively store and carry hydrogen, reduce carbon footprint due to the Haber-Bosch process, balance the nitrogen cycle by fixing atmospheric N₂, and provide means to produce on-demand fertilizers using air, H₂O, and sunlight. However, N₂ is a highly stable molecule with a strong N≡N triple bond that makes it extremely difficult to activate at ambient conditions.

Efficient integration of such NO₃⁻ reduction catalysts with green energy (e.g., solar cells) can provide opportunities to utilize wastewater and sunlight for sustainable synthesis of green ammonia. Due to the lack of efficient catalysts and solar integration schemes, solar-driven ammonia synthesis has been extremely challenging, with maximum solar-to-fuel (STF) efficiency not exceeding 1% for NH₃ produced using N₂.

Disclosed herein is a unit for producing ammonia from a nitrogen-containing feedstock that includes a nitrogen reduction unit having an inlet through which the feedstock is introduced into the unit, a cathode comprising a porous active catalyst configured to be in fluid communication with the feedstock once introduced into the nitrogen reduction unit through the inlet, wherein the active catalyst reduces one or more nitrogen containing components in the feedstock to ammonia thereby providing an ammonia product stream, and an outlet in fluid communication with the cathode and arranged downstream of the cathode for removal of ammonia from the nitrogen reduction unit; an anode electrically connected to the cathode; and electrolyte in fluid communication with the anode and cathode.

Also disclosed herein is a nitrogen reduction unit for reducing nitrogen in an input gas to ammonia that includes an inlet through which the input gas is introduced into the unit, an anode, a cathode comprising a porous active catalyst structure configured to be in fluid communication with the input gas, wherein the input gas is flowed perpendicular to the active catalysis and flows through the active catalyst, which reduces one or more nitrogen containing components in the input gas to ammonia thereby providing an ammonia product stream, electrolyte in fluid communication with the anode and cathode; and an outlet in fluid communication with the cathode and disposed downstream of the cathode.

Also disclosed herein are systems including the disclosed units and methods of using the disclosed units.

In accordance with the principles of the present disclosure, a number of systems can incorporate an ammonia-producing electrochemical cell comprising a conduit configurable to provide fluid communication with the cell from at least one of water and air. The cell comprises one or more components operably connected to the conduit to generate oxygen as a byproduct from water or to generate nitrate for the nitrate-mediated synthesis of ammonia from air. The electrochemical cell can comprise a gas diffusion electrode (GDE) with one or more late transition metals. In certain embodiments, the electrochemical cell can comprise copper as a catalyst structure on the GDE.

The electrochemical cell can comprise an active catalyst structure configured to lower activity towards hydrogen evolution reaction and lower coverages of hydrogen atom while possessing reasonable activity toward ammonia synthesis.

An exemplary system in accordance with the principles herein can comprise at least one electrochemical cell, or one or more electrochemical cells. The exemplary system can be configurable to undergo reaction conditions including an optimal pH, optimal cation, and optimal flow rate.

In some exemplary embodiments, an electrochemical cell can be adapted and constructed to undergo simultaneous production of nitric acid and ammonia from air. Exemplary electrochemical cells herein can be configured to synthesize outputs from water or air under ambient conditions.

Some exemplary systems can comprise one or more electrochemical cell operably connected, directly or indirectly, to ammonia fuel cells in order to generate electricity therefrom.

Certain electrochemical cells herein can be further defined by one or more flow through GDE cell(s).

One exemplary electrochemical cell can comprise a cobalt or similar catalyst, or group of catalysts, that can reduce nitrate to ammonia at more than 70 mAmps per cm². A suitable range can be 70 mAmps per cm² to about 600 mAmps per cm² and any intermediate values or ranges therebetween. For example, the electrochemical cell can reduce nitrate to ammonia at 70, 100, 125, 150, 175, 200, 225, 250, 275, 300, 325, 350, 375, 400, 425, 450, 475, 500, 525, 550, 575, or 600 mAmps per cm²). In addition, in exemplary embodiments, the disclosed electrochemical cells can reduce nitrate to ammonia with a selectivity of more than 70% (e.g., 70%, 75%, 80%, 85%, 90%, 95%, 96%, 97%, or 98%).

One or more exemplary electrochemical cell(s) can be connectable to one or more components in a system, constructed in accordance with the principles herein, to generate electricity from nitrate-mediated ammonia synthesis at a rate of approximately 0.5 volts per cell, or similar voltage.

In one embodiment, a new catalyst and a new electrochemical cell are set forth for the direct conversion of hydrogen to ammonia. For example, water can be directed through the electrochemical cell to make oxygen as a byproduct. Here, pure nitrogen gas can be generated to produce ammonia at ambient conditions. Thus, an electrocatalytic cell designed as a flow through gas diffusion electrode is set forth, which allows maximum contact of gas with the catalyst. As a result, the current density of the cell is small compared to current commercial processes.

In another embodiment, the electrochemical cell can include a metal catalyst, such as copper, on a GDE. A new process of converting air to ammonia with direct sparging via one or more catalyst layer(s) of the electrochemical cell is also set forth. In certain exemplary systems, ammonia fuel cells can be directly or indirectly connected to the electrochemical cell in order to operably store surplus electricity.

Some exemplary electrochemical cells oxidize nitrogen in the electrochemical cell from air in order to make nitric acid or nitrate ions, then diffuse them to the other side of the cell and reduce to make ammonia, which combines two conversion processes in one electrochemical cell. Thus, certain embodiments constructed in accordance with the principles herein can produce nitric acid and ammonia in one or more cells at ambient temperatures directly from air flow. The cells are very selective, and generate current densities of approximately three orders of magnitude higher than electrochemical cells herein configured for ammonia production from water.

A number of different products can be generated from the electrochemical cells converting ammonia including fertilizer, explosives, other chemical and electricity, for example. Further, nitrogen oxidation and nitrate conversion to ammonia will enable the treatment of waste water in certain embodiments.

A system for storing electricity can include one or more electrochemical cells constructed in accordance with the principles herein. The system can store electricity by making ammonia and storing the ammonia in a suitable storage device, such as ammonia fuel cells for example. Other components can be included to convert the ammonia stored in the fuel cells to electricity as needed. Thus, off-grid production of electricity can be achieved in accordance with certain exemplary embodiments herein. Also, fertilizer can be generated on-demand in accordance with the principles herein. Such embodiments enable the on-site production of fertilizer, if desired.

An exemplary method of manufacturing an electrochemical cell can comprise forming an electrochemical cell configured to function at ambient conditions, according to the overall reaction 4 N₂ + 9 H₂O → 3 HNO₃ + 5 NH₃ (E° = - 0.432 V) and the two half-cell reactions:

Anode: N₂ + 12OH ↔ 2 NO₃⁻ + 6H₂O + 10 e 2 3 2

Cathode: NO₃⁻ + 6H₂O + 8e ↔ NH₃ + 9OH⁻ ; and packaging the electrochemical cell for shipment.

An exemplary method of producing ammonia and nitrates simultaneously and at ambient conditions can comprise operably disposing a conduit of an electrochemical cell in fluid communication with at least one fluid selected from air, water, ANSOL, or wastewater; and reacting the at least one fluid with a catalyst to produce ammonia or nitrates.

Other embodiments can generate needed by products or chemicals required during space exploration. Arms and munitions can also be formed via nitrate byproducts from systems and electrochemical cells as set forth herein. Waste water can be converted in underdeveloped countries using systems herein, if desired. Other applications and examples not specifically set forth are contemplated as well.

### BRIEF DESCRIPTION OF FIGURES

FIG. 1A illustrates an exemplary electrochemical cell wherein distribution of H₂O and N₂ near the electrocatalyst with a planar electrode, wherein coverage of N₂ is limited by its solubility in H₂O.

FIG. 1B illustrates an exemplary electrochemical cell wherein distribution of H₂O and N₂ near the electrocatalyst with a gas-diffusion electrode or porous electrode configurations for aqueous electrochemical cells, wherein N₂ can be controlled independently by adjusting the pressure of N₂ at the backside of GDE.

FIG. 1C illustrates the effect of increasing pH and cation size on H₂O re-organization, *H binding, and stabilization of intermediates, wherein increasing the pH increases the *H coverage and re-orients H₂O to the O-down position on the cathode, and increasing the cation size stabilizes the NRR intermediates and also allows direct reduction of H₂O in the solvation shell of larger cations.

FIG. 2A is a scanning electron micrograph (SEM) of Cu-coated carbon paper before electrolysis at magnifications of x30 showing uniformity of electrodeposited Cu over carbon fibers and at x9000 showing plate-like crystals of Cu.

FIG. 2B illustrates a grazing incidence x-ray diffraction (GI-XRD) spectrum confirming the presence of distinct crystallographic planes (111) and (100) on electrodeposited Cu (Cu-GDE) as compared to polycrystalline Cu film (Cu).

FIG. 2C is an X-ray photoelectron spectrum for Cu-coated carbon paper, which shows binding energies specific to Cu, O, and C.

FIG. 2D illustrates chronoamperometry data of total current density versus time at -0.5 V vs. RHE shows the stability of the catalyst.

FIG. 2E is a scanning electron micrograph of Cu-coated carbon paper after chronoamperometry showing some smearing of Cu on carbon paper, which can be due to potential-driven aggregation of Cu crystals.

FIG. 3A illustrates the Faradaic efficiencies and current densities of NH₃ as a function of applied potential on the kinetics of NRR over Cu-coated GDE under the following conditions: pH - 13.5, electrolyte - 0.32 M KOH, N₂ gas flowrate- 150 sccm, electrolyte flowrate – 5 ml min⁻¹, and ambient temperature and pressure.

FIG. 3B illustrates the calculated pH values at the interface of GDE and bulk electrolyte as a function of applied potential under the conditions of FIG. 4A, wherein the decrease in current density in (4A) is due to the increase in cathode pH (4B).

FIG. 4A illustrates the Faradaic efficiencies and current densities of NH₃ as a function of pH under the following conditions: applied potential - -0.5 V vs. RHE, electrolyte -KOH of varying pH for (A), and 0.32 M MOH (M= Li, Na, K, Rb, and Cs) of pH 13.5 for (B), N₂ gas flowrate - 150 sccm, electrolyte flowrate - 5 ml min⁻¹, ambient temperature and pressure.

FIG. 4B illustrates the Faradaic efficiencies and current densities of NH₃ as a function of cation identity under the conditions of FIG. 5A.

FIG. 5A illustrates the measured FE and current density of NH₃ as a function of volumetric flow rate of N2 under the following experimental conditions: applied potential - -0.5 V vs. RHE, pH - 13.5, electrolyte - 0.32 M KOH, N₂ gas flowrate - fixed at 150 sccm, electrolyte flowrate - 5 ml min⁻¹, ambient temperature and pressure.

FIG. 5B illustrates the average H₂O concentration in the GDE calculated for different flow rates of N_{2(g)}.

FIG. 5C illustrates the calculated values of average velocity and boundary layer thickness at the GDE-electrolyte interface with increasing N_{2(g)} flowrate.

FIG. 5D illustrates the increase in the concentration of dissolved N₂₍ₗ₎ with increasing N_{2(g)} flowrate, wherein the increase in FE (6A) is due to decrease in HER current density, which is caused by decrease in average H₂O concentration (6B), and wherein the increase in NH₃ current density (6A) is due to decrease in boundary layer thickness (6C) followed by increase in dissolved N₂ concentration (6D).

FIG. 6 illustrates the increase in NH₃ FE and current density with the increasing mole fraction of N₂ in the gas feed under the following experimental conditions: applied potential -0.5 V vs. RHE, pH13.5, electrolyte - 0.32 M KOH, N₂ gas flowrate - 150 sccm, electrolyte flowrate - 5 ml min⁻¹, and ambient temperature and pressure.

FIG. 7 illustrates schematically a transfer processes and reaction happening in an exemplary electrochemical cell device.

FIG. 8 illustrates an electrochemical cell constructed in accordance with the principles herein. The electrochemical cell oxidizes N₂ from the air to produce HNO₃ at anode, where additional nitrate ions produced are diffused to the cathode to yield NH₃.

FIG. 9 illustrates another exemplary system incorporating an electrochemical cell constructed in accordance with the principles herein.

FIG. 10A illustrates the NH₃ Faradaic efficiency and NH₃ current density on polycrystalline Fe, Co, Ni, Cu, and Zn metal plates in 1 M KNO₃ electrolyte at -0.8 V vs. RHE.

FIG. 10B illustrates linear sweep voltammetry (LSV) curves of Co on different substrates: PTFE (Co/PTFE), Graphite Planchet (Co/GP), and Co metal. OD-Co is supported on Co metal plate when measured in 1 M KNO₃ of pH 7 at a sweep rate of 5 mV/s.

FIG. 10C illustrates a comparison of LSVs normalized by electrochemical surface area (ECSA) of OD-Co and bare Co metal.

FIG. 11A illustrates A) NH₃ FE and current density as a function of pH at -0.6 V vs. RHE.

FIG. 11B illustrates NH₃ FE and current density as a function of applied potential using 1 M KNO₃ at pH 14.

FIG. 11C illustrates NH₃ FE and current density as a function of applied potential using 1 M KNO₃ at near neutral pH.

FIG. 11D illustrates NH₃ FE and current density as a function of different NO₃⁻ concentrations.

FIG. 11E illustrates current density as a function of time for a 24 h stability run at an applied potential of -0.4 V vs. RHE and pH 14.

FIG. 11F illustrates NH₃ FE vs. geometric current densities reported in the literature.

FIG. 11G illustrates NH₃ FE vs. active-area-normalized (specific) current densities. The highest specific current density is obtained in this study.

FIG. 12A illustrates a schematic of PV-electrolyzer system for solar-driven NH₃ synthesis. A GalnP/GaAs/Ge triple-junction solar cell powers the electrochemical cell consisting of Ni foam for OER and OD-Co for NiRR in 1 M KNO₃ electrolyte of pH 14.

FIG. 12B illustrates the intersection of JV characteristics of GalnP/GaAs/Ge triple-junction solar cell at 1 sun of AM1.5G irradiance with the load curve of an electrochemical cell, wherein the operating current is 300 mA and the potential is 2 V.

FIG. 12C illustrates the stable operating current, FE of NH₃, and STF efficiency over 3 hours.

FIG. 13A illustrates the effect of applied potential for the electrochemical reduction of simulated wastewater.

FIG. 13B: Stable operating current, FE of NH₃, and STF efficiency for the reduction of simulated wastewater containing just 3 mM Nitrates over 3 hours.

FIGS. 14A illustrates the NH₃ Faradaic efficiency as a function of copper loadings.

FIG. 14B illustrates the LSV profiles for Planar Cu, Cu GDE sparged with N₂ and Ar, and blank GDE.

FIG. 14C illustrates the NH₃ Faradaic efficiency as a function of applied potential.

FIG. 14D illustrates the NH₃ production rate as a function of applied potential.

FIG. 15 illustrates a flow-through Gas Diffusion Electrode (GDE) Electrochemical Cell Schematic.

FIG. 16 illustrates H₂ Faradaic Efficiency and H₂ Current Density as a function of applied potential.

FIG. 17 illustrates NH₃ solubility as a function of pH.

FIG. 18 illustrates H₂ Faradaic efficiency and the current densities as a function of pH.

FIG. 19 illustrates Faradaic Efficiency and Current Density as a function of cations.

FIG. 20 illustrates H₂ Faradaic efficiency and current density as a function of the flow rate.

FIG. 21 illustrates H₂ Faradaic efficiency and current density as a function of mole fraction.

### DETAILED DESCRIPTION

The present disclosure provides units, systems, and methods for producing ammonia from a nitrogen-containing feedstock. In some aspects, the disclosure provides systems and methods for producing ammonia by reducing nitrate. In some aspects, the disclosure provides systems and methods for producing ammonia by reducing nitrogen. In some aspects, the disclosure provides systems and methods for producing ammonia by oxidizing nitrogen to nitrate followed by reducing nitrate to ammonia.

Applying an electric potential to an electrocatalyst can substantially reduce the activation barrier for N₂ reduction reaction (NRR) for the synthesis of NH₃ at ambient conditions. The outstanding challenge is to minimize the over-reduction of the proton source- H₂O in the hydrogen evolution reaction (HER) while promoting the NRR. Through use of a theory-guided approach, efficient NRR catalysts and strategies have been found to increase activity and selectivity of NRR by optimizing the composition of inner Helmholtz plane by varying electrolyte pH, cation-type, H₂O saturation, and dissolved N₂ concentration.

Although the difference in the equilibrium potential between HER and NRR (shown below) is minimal ~57 mV, the HER is kinetically dominant than NRR for most catalytic systems.

| | | |
|---|---|---|
| (NRR) | N₂ + 6H₂O + 6e⁻ → 2NH₃ + 60H⁻ | E⁰ = 0.057 V vs. RHE |
| (HER) | 2H₂O + 2e⁻ → H₂ + 20H⁻ | E⁰ = 0 V vs. RHE |

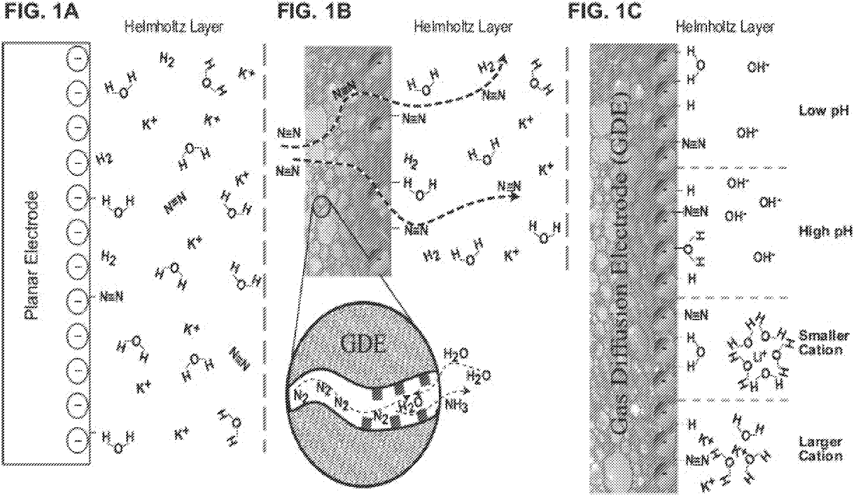

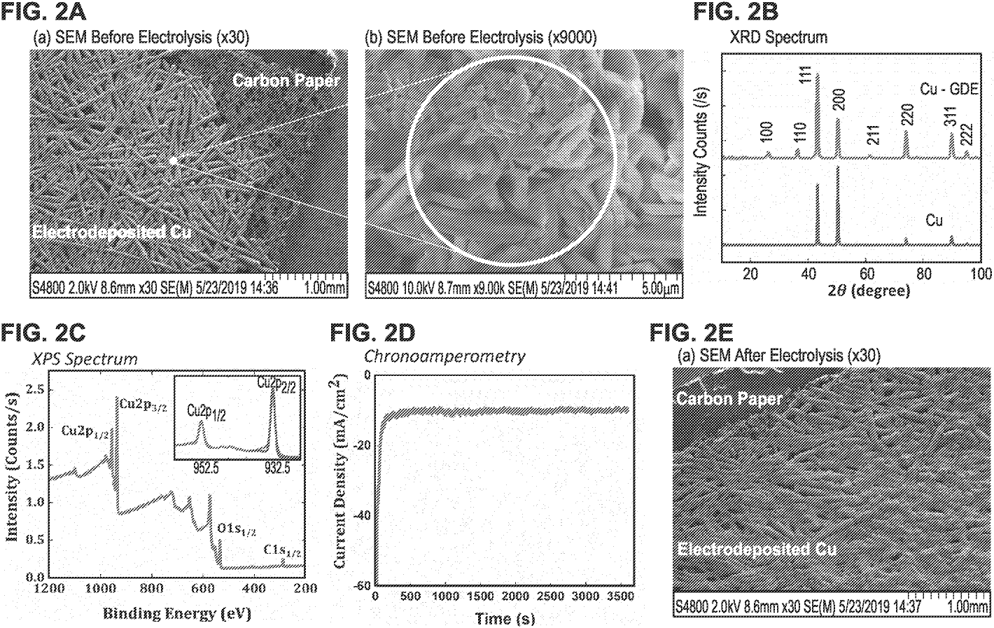

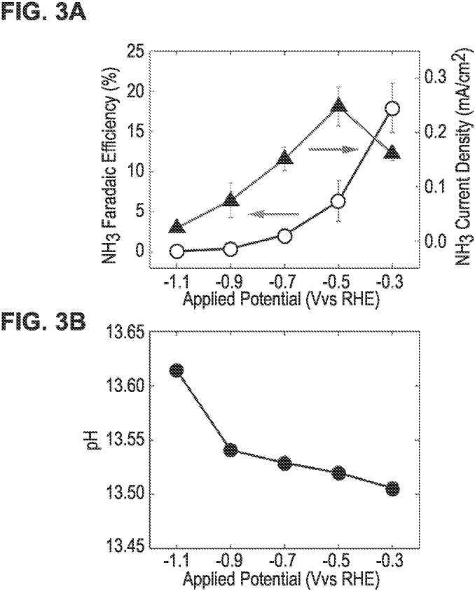

This is because the concentration of H₂O is at least three orders of magnitude higher than the solubility limit of N₂ - 1.3 × 10⁻³ mol L⁻¹ in H₂O, and the binding energy of H₂O/H on most transition metals are also higher than N₂. The lower solubility and lower binding energy of N₂ in aqueous electrolytes are the primary cause for much lower coverages of NRR intermediates and thereby activity and faradaic efficiency (FE) of NH₃ on planar electrodes (see schematic in FIG. 1A). Broadly, it has been found that three different hierarchical approaches can be applied to improve the activity and FE of NRR, namely, design of catalyst, engineering of electrolyte, and optimization of the electrochemical cell.

The first approach is primarily guided by density functional theory (DFT) for the discovery of efficient NRR catalysts that surpass the fundamental limits of existing catalysts for the scalable synthesis of NH₃ at ambient conditions. Extensive DFT studies have been performed to study NRR; however, most only focus on the binding energies of the intermediates in a slab/vacuum model and do not consider the effect of liquid electrolyte, applied potential, and coverages of *H. A recent DFT study reported a kinetic volcano of activation barriers representing a trade-off between weak versus strong N-binding transition metals for optimal NRR. They showed early transition metals of high N-binding favor dissociative mechanism with hydrogenation of *NH as the rate-limiting step; whereas the late transition metals of lower N-binding support associative mechanism with hydrogenation of *N₂ as the rate-limiting step. Similar trends in NRR activity of transition metals have been obtained by calculating the free energy change of elementary steps. However, these DFT studies have also reported higher activity of HER on transition metals as compared to NRR, demonstrating an extreme challenge for the identification of efficient NRR catalysts. Besides consideration of the relative activation barriers for HER and NRR, the relative coverages of *H and *N₂ are also crucial in determining the activity and FE of NRR.

It has been found in the methods and units herein that the most efficient NRR catalysts are the materials with lower HER activity (higher activation barrier) and lower *H coverages, while also possessing reasonable energy barriers for NRR. Methods and units of the disclosure can utilize group-11 elements such as Cu, Ag, and Au, which have NRR activity with lower HER activity and lower *H coverages (<10%). To accurately model the steps of NRR on these transition metals, the fixed potential DFT (FP-DFT) calculations that include the previously unaccounted effects of solvation and applied potential within the Kohn-Sham DFT (KS-DFT) method were performed.

The second strategy to increase the efficiency of NRR catalysts was to engineer electrolyte composition and operating conditions. A most common operating strategy is to apply a lower cathodic overpotential to minimize HER, which also limits the NRR current density significantly. High-temperature and high-pressure electrochemical cells have been used to improve the FE of NRR, which had a marginal effect on the FE even at the operating temperature of 373 K and operating pressure of 60 bar. Another possibility is to use nonaqueous electrolytes that can increase the solubility of N₂ and reduce HER. The effects of electrolyte composition such as pH and cations on NRR have also been studied empirically, but a satisfactory explanation of these effects has not been developed yet. For instance, the electrolyte pH is known to affect the binding energy of H, the solubility of NH₃, and the re-organization of H₂O; whereas the electrolyte cations are known for stabilizing the polar intermediates, and facilitating HER. How these effects of pH and cations modulate the NRR and HER have not been well-studied. FIG. 1C depicts the competing effects of pH and cations on the composition of the double layer and thereby kinetics of NRR and HER.

The third strategy was to improve the electrochemical cell to increase the mass transfer of N_{2(g)} and to decrease the energy losses. The performance of NRR in a planar electrode geometry suffers from higher H₂O concentrations and lower N₂ coverages, as depicted in FIG. 1A. Even at the lower NRR current densities ~1 mA cm⁻², the dissolved N₂ near the planar electrode can deplete and decrease the FE of NRR substantially. Most NRR studies reported in the literature are affected by N₂ depletion at higher negative potentials. To overcome these issues, a flow-through gas-diffusion electrode (GDE, see FIG. 1B) can be used herein, which promotes higher N₂ coverage, modulate the concentration of H₂O, and reduce N₂ mass-transfer resistance at the catalyst surface. The operation of the flow-through GDE of the disclosure is different than a conventional GDE, at least in that the convection of gas is parallel to the plane of GDE.

The action of the flow-through GDE simultaneously converts gas to chemicals using applied electric potential. Increasing the flow rate of N_{2(g)} through the GDE decreases the volume fraction of H₂O and thereby increases the gas coverage on the GDE. The lowering of H₂O coverage on GDE was found to suppress HER substantially and thus promote FE of NRR. The effect of H₂O coverages on electrochemical reactions has never been investigated for aqueous systems. This flow-through GDE configuration offers a versatile platform to modulate H₂O coverages on electrocatalysts.

Units and methods of the disclosure were developed through an integrated theoretical and experimental approach for the rational design of catalysts, electrolyte composition, and electrochemical cells to improve the activity and FE of NRR. A new hypothesis-driven descriptor for efficient NRR catalyst was identified, followed by an accurate evaluation of NRR mechanism at the electrode-electrolyte interface using FP-DFT. The composition of the Helmholtz layer in the units of the disclosure has been tuned through adjustment of the electrolyte pH, cation-type, and H₂O saturation. Flow-through GDE can be used to modulate N₂ and H₂O concentrations and the boundary layer for enhanced N₂ mass transfer.

Experimental methods, which include the composition of materials used herein, electrode and electrolyte preparation and characterization techniques, electrochemical cell setup, and quantification of NH₃ are set forth below, including DFT calculations for elementary steps of NRR on Cu, Ag, and Au, and multiphase, multiphysics simulations to calculate pH gradients, N_{2(g)} distribution, H₂O saturation in GDE, dissolved N₂, and velocity profiles in the cell. Results such as reaction mechanism and energy profile of NRR, catalyst structure and composition, and NH₃ current density and FE as a function of applied potential, pH, cation-type, N_{2(g)} flow rate, and partial pressure are provided below.

In accordance with the principles herein, systems, processes and electrochemical cells that can oxidize N₂ from the air to produce HNO₃ at anode, where additional nitrate ions produced are diffused to the cathode to yield NH₃ are set forth. Other methods and units of the disclosure can alternatively or additionally convert water or wastewater into ammonia.

Methods and units of the disclosure can be configured to produce on-demand fertilizer or store electricity. Incorporating one or more suitable and efficient N₂ reduction reaction (NRR) catalyst(s) in one or more electrochemical cells, followed by implementation of the catalyst in a flow-through gas diffusion electrode (GDE) resulted in quantifiable effects of pH, cation-identity, H₂O saturation, and N₂ concentration on the kinetics of NRR for suitable catalysts. Further, flow rate results can be scalable, in accordance with the principles herein.

Units and methods of the disclosure can provide an integrated system that can i) directly utilize air using a flow-through GDE to produce HNO₃ by eliminating mass transfer resistance of N₂ and minimizing the production of O₂ ii) has a net-negative cell potential, and iii) separately produce NH₃ at greater than 90% selectivity to develop active and selective electrocatalysts for N₂ oxidation reaction (NOR) and NO₃⁻ reduction reactions (NRR) to produce HNO₃ and NH₃, respectively.

The disclosure provides methods of converting producing ammonia from air and water directly without requiring separation of nitrogen and at ambient conditions, if desired.

### Nitrogen-Containing Feedstock

In keeping with an aspect of the disclosure, the nitrogen-containing feedstock includes one or more nitrogen-containing species capable of being converted to ammonia. In some embodiments, the nitrogen-containing species is selected from the group consisting of N₂, NO₃⁻, NO₂⁻, NOₓ, and a combination thereof. For example, in some embodiments, the nitrogen-containing feedstock includes or is an input gas containing one or more nitrogen-containing species (e.g., nitrogen). In some embodiments, the nitrogen-containing feedstock includes or is NO₃⁻. Conversion of NO₃⁻ to NH₃ advantageously offers a pathway for recycling NO₃⁻ discharged in municipal and industrial wastewater and agricultural runoff water, thereby balancing the N₂ cycle. As such, in some embodiments, the nitrogen-containing feedstock includes or is water. By way of example, in some embodiments, the nitrogen-containing feedstock includes or is a waste water stream containing one or more nitrogen-containing species, as described herein. The number of feedstocks is not particularly limited. For example, in some embodiments, the units, systems, and devices of the disclosure are configured to permit processing of more than one feedstock (e.g., 2, 3, or 4), for example, a first and a second feedstock are flowed into a unit. In exemplary embodiments, the systems can contain one or more units, wherein one of the units processes a feedstock flowing from an output of an upstream unit while simultaneously receiving a second input from an external source (e.g., waste stream containing one or more nitrogen-containing species).

As described herein, the units, devices, and systems of the disclosure contain various elements configured in various arrangements for the desired application or function. By way of example, each of the units, systems, and/or devices of the disclosure can independently include one or more components selected from the group consisting of one or more inlets; one or more outlets; one or more anodes, one or more cathodes, one or more nitrogen reduction units, one or more nitrogen oxidation units, one or more nitrate reduction systems, one or more ion (e.g. anion) exchange membranes; and any combination thereof.

### Nitrogen Reduction Unit

In keeping with an aspect of the disclosure, the described units for producing ammonia include a nitrogen reduction unit. The nitrogen reduction unit contains at least one inlet through which one or more feedstocks are introduced into the unit; a cathode containing a catalyst; an outlet; an anode; and electrolyte.

The cathode containing the catalysts is described in detail herein and can generally include a late transition metal catalyst disposed on a porous conductive substrate.

The electrolyte can be an aqueous electrolyte. The electrolyte can be, for example, KOH. [Inventors, please list any others. Any concentrations of the KOH that are particularly relevant?]. Methods, units and systems of the disclosure in which the feedstock is a nitrogen containing input gas, the electrolyte can be aqueous KOH.

The nitrogen reduction units of the disclosure advantageously reduce the feedstock containing nitrate to ammonia with a selectivity of 70% or more (e.g., 70%, 75%, 80%, 85%, 90%, or 95% or more). In embodiments wherein nitrogen is directly reduced to ammonia, the selectivity for the conversion can be 10% or more (e.g., 10%, 15%, 20%, or 25% or more). In addition, the disclosed nitrogen reduction unit can reduce the feedstock to ammonia at more than 70 mA/cm². Moreover, the nitrogen reduction unit of the disclosure consumes electricity in an amount of about 0.5 volts per cell.

### Nitrogen Oxidation Unit

In some embodiments, the disclosed unit contains a nitrogen oxidation unit upstream of the nitrogen reduction unit. Typically, the nitrogen oxidation unit contains an inlet, an anode, and an outlet. Suitable non-limiting examples of anode catalysts include catalyst comprising platinum and/or nickel and the electrolyte at the anode typically contains potassium ions (e.g., KOH). In keeping with aspects of the disclosure, the input gas is flowed perpendicular to the anode when reducing nitrogen using a GDE, as described herein. The catalyst can be supported on different conductive substrates. For example, the assembly of catalyst on substrate can make the anode. Suitable catalysts for N₂ oxidation are the ones that have a higher overpotential for the oxygen evolution reaction (side reaction). Non-limiting examples include Fe₂O₃, LaCoO₃, NiCeOₓ, NiCuOₓ, NiOₓ, FeMn(Oₓ), NiLa(Oₓ). The other potential N₂ oxidation catalysts are PtOₓ, TiO₂, and PbO₂. Typically, GDEs are best suited for reactions involving gas. The GDE can be operated by flowing gas parallel to the GDE surface or perpendicular to GDE surface. Desirably, the catalyst and/or the electrode are porous for N2 gas feed. However, in the case of reduction of nitrate, planar electrodes such as oxide-derived Co can be suitable. In some embodiments, the system is operated using a flow-through configuration. In some embodiments, the input gas is flowed perpendicular to the anode as with the reduction process. In accordance with aspects of the disclosure, the nitrogen oxidation unit contains an electrolyte. For oxidation, the pH of the electrolyte is typically in a range of 7 to 14 (e.g., 7, 7.5, 8, 8.5, 9, 9.5, 10, 10.5, 11, 11.5, 12, 12.5, 13, 13.5, or 14). A suitable non-limiting electrolyte is 1 M KOH (pH 14) or 0.1 M KOH (pH 13) or less, with our without nitrate present. The cation can also be different such as Na, Rb or Cs.

The inlet functions to introduce an input gas containing nitrogen into the nitrogen oxidation unit.

The anode is in contact with an anolyte, wherein the anode is configured to be in fluid communication with the input gas and the anode comprising a catalyst configured to oxidize nitrogen in the input gas to nitrate thereby providing a nitrate product stream.

The outlet is in fluid communication with the anode and the nitrate reduction unit and functions to flow the nitrate product stream from the anode, for example, to the inlet of a downstream nitrogen reduction unit.

In some embodiments, the disclosure provides a nitrate reduction system that includes one or more of the disclosed units and an energy source configured to power the system. In some embodiments, the energy source comprises a wind energy source or a solar cell. In some embodiments, the energy source is a solar cell.

The solar cell is not particularly limited. In some embodiments, the solar cell is a GalnP/GaAs/Ge triple-junction solar cell.

In some embodiments, the disclosed nitrate reduction systems further comprise an ammonia storage/conversion device (e.g., an ammonia fuel cell).

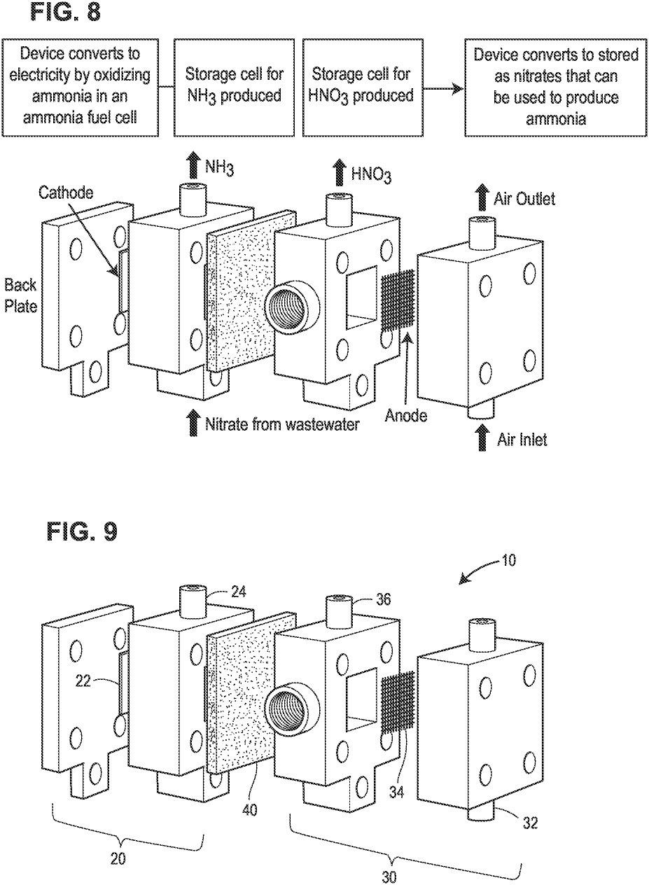

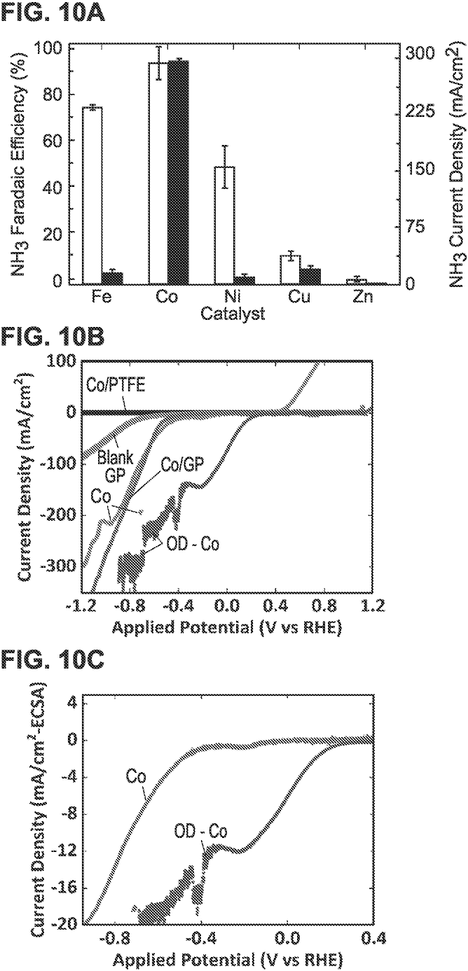

In some embodiments, the disclosed nitrate reduction systems include a nitrogen oxidation unit upstream of a nitrogen reduction unit and an energy source configured to power the system. In this configuration, the nitrate reduction systems contain an anion exchange membrane disposed between the nitrogen oxidation unit and the nitrate reduction unit, wherein the anion exchange membrane is in fluid communication with the nitrogen oxidation unit and the nitrate reduction unit and the membrane facilitates diffusion and migration of nitrate from the nitrogen oxidation unit to the nitrate reduction unit. FIG. 8 is a schematic of the operation of exemplary embodiments of nitrate reduction system containing nitrogen oxidation unit and nitrogen reduction.

### Inlet(s) and Outlets

The inlet functions as a conduit to flow material containing the nitrogen-containing species (e.g., feedstock, input gas) into the unit. The number of inlets is not particularly limited (e.g., 1, 2, 3, and the like). For example, in some embodiments, the nitrogen reduction unit contains one inlet through which the feedstock is introduced into the unit. Alternatively, the nitrogen reduction unit can contain an additional inlet (i.e., two inlets) for introducing a second feedstock into the unit.

The outlet functions as a conduit to flow product streams (e.g., nitrate product stream or ammonia product stream) out or away from the unit. The number of outlets is not particularly limited (e.g., 1, 2, 3, and the like). For example, in some embodiments, the nitrogen oxidation unit contains one inlet through which a nitrate product stream flows out of the unit (e.g., into the downstream nitrogen reduction unit) and an outlet for nitric acid.

### Cathode/Catalysts

In keeping with an aspect of the disclosure, the disclosed units for preparing ammonia contain a cathode containing a porous active catalyst configured to be in fluid communication with the nitrogen-containing feedstock and/or input gas once introduced into the nitrogen reduction unit through the inlet, wherein the active catalyst converts one or more nitrogen-containing species or components in the nitrogen-containing feedstock or input gas to ammonia thereby providing an ammonia product stream. Typically, the catalyst is arranged such that the feedstock introduced into the unit through the inlet is flowed through the catalyst. In embodiments, the unit operates in a continuous flow-through mode.

In some embodiments, the cathode includes a porous active catalyst configured to be in fluid communication with the feedstock once introduced into the nitrogen reduction unit through the inlet, wherein the active catalyst reduces one or more nitrogen-containing components in the feedstock to ammonia thereby providing an ammonia product stream.

In some embodiments, the cathode includes a porous active catalyst structure configured to be in fluid communication with the input gas, wherein the input gas is flowed perpendicular to the active catalysis and flows through the active catalyst, which reduces one or more nitrogen-containing components in the input gas to ammonia thereby providing an ammonia product stream.

Although the catalyst can vary depending on the desired application, the catalyst is capable of converting one or more nitrogen-containing species to ammonia. Typically, the catalyst is a transition metal catalyst. In some embodiments, cathode includes a transition metal catalyst deposited on a porous conductive substrate. In some embodiments, the transition metal catalyst is electrodeposited onto the porous conductive substrate. The porous conductive substrate can be, for example, a fibrous conductive substrate. In some embodiments, the porous conductive substrate is carbon paper.

In some embodiments, in conjunction with other above or below embodiments, the catalyst contains a late transition metal catalyst (e.g., selected from iron, cobalt, nickel, copper, silver, gold, zinc, and a combination thereof). In some embodiments, particularly those embodiments wherein nitrate is reduced to ammonia, the late transition metal catalyst is cobalt. In some embodiments, the cobalt contains or is a cobalt oxide. In some embodiments, the cobalt oxide is oxide-derived cobalt (OD-Co). In some embodiments, particularly those embodiments wherein nitrogen is reduced to ammonia, the late transition metal catalyst is copper. In some embodiments, the copper is arranged such that the (111) facets are dominant.

Catalysts of the disclosure can be formulated on gas diffusion electrodes (GDEs). Properties such as porosity and hydrophobicity, can be tuned in order to enhance the N₂ accessibility on the active reaction sites, owing to its low solubility in H₂O. For example, in some embodiments, the porosity can be from about 20% to about 50% (e.g., 20%, 25%, 30%, 35%, 40%, 45%, or 50%). Embodiments herein and contemplated herein achieve electrocatalytic synthesis of HNO₃ and NH₃ from N₂ (from the air) and H₂O at ambient conditions.

Requirements for suitable catalysts can vary. However, the most efficient NRR catalysts are the materials with lower HER activity (higher activation barrier) and lower *H coverages, while also possessing reasonable energy barriers for NRR.

A flow-through gas-diffusion electrode (GDE) electrochemical cell (see FIG. 1B) can promote higher N₂ coverage, modulate the concentration of H₂O, and reduce N₂ mass-transfer resistance at the catalyst surface.

The GDE can provide perpendicular flow, rather than parallel flow found in conventional GDE’s, can be a porous electrode, and can have a catalyst layer (hydrophilic) and the noncatalytic (hydrophobic) part. The catalyst part can be completely wetted by water, and the incoming N₂ can force the water out of the catalyst layer.

For example, a Cu catalyst with dominant (111) facets can be electrodeposited on a carbon paper to provide active sites to obtain maximum NH₃ faradaic efficiency (FE) of 18±3 % at -0.3 V vs. RHE and the maximum NH₃ current density of 0.25 ± 0.03 mA cm⁻² (2.14 nmol.cm⁻ ².s⁻¹) in alkaline medium.

In certain embodiments, H₂O saturation of less than 0.6 gives more ammonia production since water can be displaced by flow through the catalyst.

In certain embodiments, a flow-through cell can be incorporated into an electrochemical cell configured to carry water through a fluid conduit and a catalyst operably connected to the conduit can make oxygen as a by-product, as illustrated in FIG. 1. The flow-through cell can be a GDE incorporating one or more late transition metals. In other embodiments Copper as a Catalyst can be incorporated into the structure of the GDE.

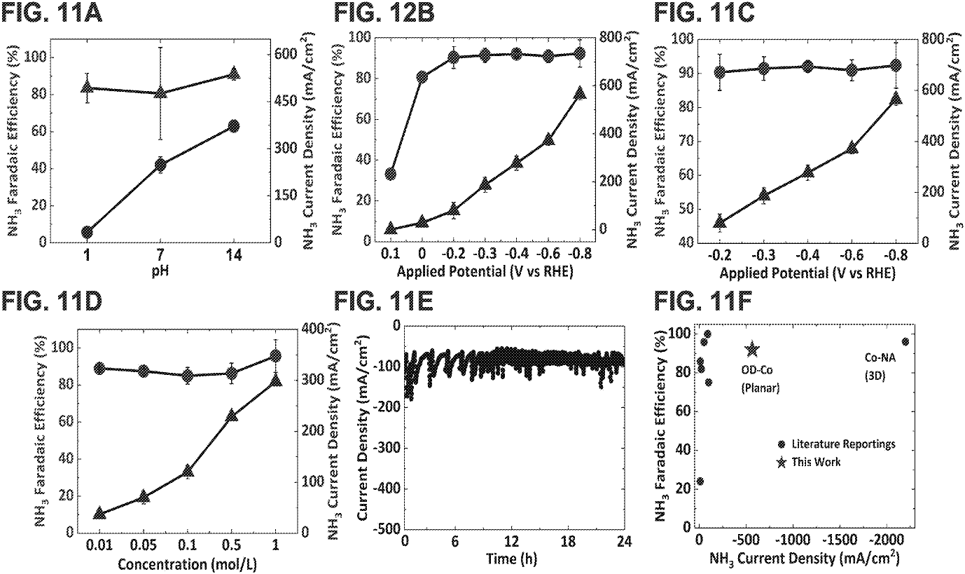

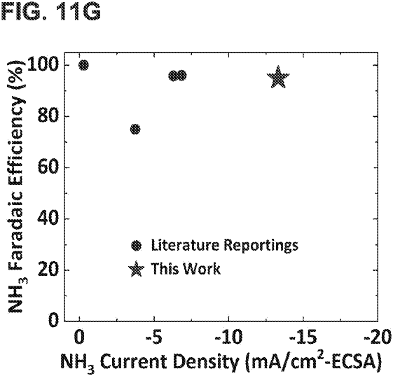

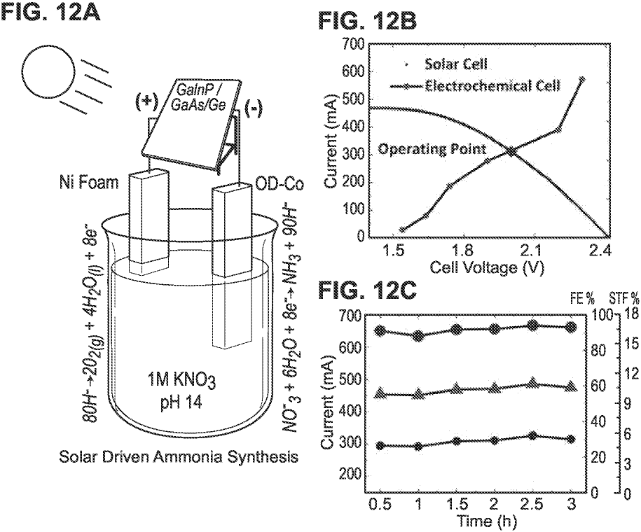

Electrochemical cells and systems herein can be configured to achieve simultaneous production of nitric acid and ammonia, as illustrated in FIGS. 11 and 12. Such cells and systems can produce electricity via ammonia stored in suitable device components, for example, ammonia fuel cells, that can be operably connected to cell.

In various units, systems and methods of the disclosure, cobalt can be used as the catalyst. It has been found that use of cobalt as a catalyst can reduce nitrate to ammonia at more than 70 mAmps per cm2 and selectivity of more than 70%, as described herein, for example, 70, 100, 125, 150, 175, 200, 225, 250, 275, 300, 325, 350, 375, 400, 425, 450, 475, 500, 525, 550, 575, or 600 mAmps per cm² and/or 70%, 75%, 80%, 85%, 90%, 95%, 96%, 97%, or 98% selectivity. Electricity production has been achieved at approximately 0.5 volts per cell.

### Anode

The units of the disclosure comprise a suitable anode electrically connected to a cathode. In keeping with an aspect of the disclosure, the anode can function to oxidize one or more nitrogen-containing species (e.g., nitrogen) into nitrate.

In some embodiments, the anode is in contact with an anolyte, wherein the anode is configured to be in fluid communication with the input gas and the anode includes a catalyst configured to oxidize nitrogen in the input gas to nitrate, thereby providing a nitrate product stream.

### Electrolyte

In keeping with an aspect of the disclosure, the disclosed units include a suitable electrolyte in fluid communication with the anode and cathode. Typically, the electrolyte contains potassium ions. Typically, the electrolyte is aqueous.

Typically, the electrolyte has a pH of about 13-14. In some embodiments, the electrolyte has a pH of about 13.5.

The disclosure also provides methods for preparing ammonia using any of the units and systems described herein arranged in a suitable configuration.

Referring to FIG. 12, the nitrate reduction systems 10 of the disclosure can include a nitrate reduction unit 20 and a nitrogen oxidation unit 30 upstream of unit 20. System 10 further includes an anode 34, an anion exchange membrane 40 disposed between units 20 and 30, and a cathode 22, as described herein. A nitrogen-containing feedstock (e.g., input gas) containing one or more nitrogen-containing species (e.g., air containing N₂) flows into unit 30 via the inlet 32, wherein one or more nitrogen-containing species (e.g., N₂) contacts anode 34, whereupon one or more of the nitrogen-containing species is oxidized to nitrate thereby providing a nitrate product stream 36. In addition, units 30 and 20 are in fluid communication and configured such that at least a portion of the nitrate product stream passes through membrane 40 and into unit 20, whereupon contact with cathode 22, nitrate is reduced to ammonia thereby producing an ammonia product stream 24.

Referring to FIG. 11, the system 10 can further include separate storage for the product streams. For example, a portion of nitrate stream 36 can be collected in a storage cell, wherein the stored nitrates can be used to produce ammonia. Similarly, ammonia stream 24 can be collected in a storage cell, wherein the stored ammonia can be converted to electricity by oxidizing ammonia.

In addition, in some configurations, unit 20 can include a second input for a second feedstock (e.g., wastewater containing nitrates).

### Theoretical Modeling

Following the approach of Goldsmith and coworkers, we consider the following mechanism for electrochemical nitrate reduction:

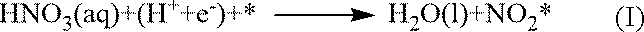

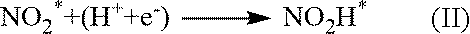

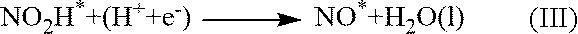

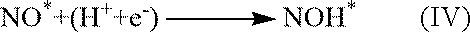

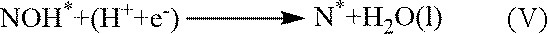

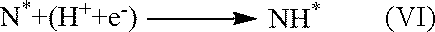

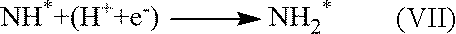

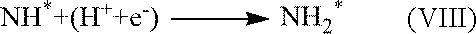

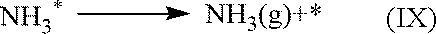

COMSOL Simulations - Effect of Applied Potential on the pH Around Cathode Boundary: A one-dimensional electrochemical cell for NRR was developed to determine the pH near the cathode boundary as a function of the applied potential. The Pt anode is used for water oxidation and Cu GDE cathode is used for NRR. The anolyte and catholyte are separated by an anion-exchange membrane - Excellion of 100 µm thickness.

Polarization Losses: Polarization loss due to transport of species (by migration and diffusion) and concentration gradients can be represented as a sum of i) ohmic loss, ii) diffusion loss, and iii) Nernstian loss. The ohmic loss is due to the resistance of the electrolyte, and the diffusion loss originates from the ionic gradient in the boundary layer near each electrode due to the applied current density. The ohmic and diffusion losses can be combined into the solution loss such that

$$\text{Δ} {ϕ}_{\text{solution}} = {\underbrace{\int \frac{{i}_{l}}{κ} d x}}_{\text{Δ} {ϕ}_{\text{ohmic}}} + {\underbrace{{\sum }_{i} \int \frac{F {z}_{i} {D}_{i} ∇ {c}_{i}}{κ} d x}}_{\text{Δ} {ϕ}_{\text{diffusion}}} \qquad \text{(1)}$$

where iₗ is the electrolyte current density, K is the electrolyte conductivity, x is the position, F is Faraday’s constant, zᵢ is the charge number, Dᵢ is the diffusion coefficient, and cᵢ is the concentration of the i^{th} species. The ionic gradients alter the concentrations of reacting species next to the electrode surfaces (e.g., protons, hydroxide anion, and dissolved N₂) away from those present in the bulk. This causes an increase in the equilibrium potential of the oxygen evolution reaction (OER) and the Nitrogen reduction reaction (NRR), which are referred to collectively as the Nernstian loss. The Nernstian loss is a sum of losses due to differences in pH at the two electrodes, and differences in concentration of N₂ at the cathode and in the bulk, electrolyte is given by

$$\begin{matrix}\text{Δ} {ϕ}_{\text{Nernstian}} = {\underbrace{\frac{2.303 R T}{F} \left({\text{pH}}_{\text{cathode}} - {\text{pH}}_{\text{bulk}}\right)}}_{\text{Δ} {ϕ}_{\text{cathode} \text{pH}}} + \\ {\underbrace{\frac{2.303 R T}{F} \left({\text{pH}}_{\text{bulk}} - {\text{pH}}_{\text{anode}}\right)}}_{\text{Δ} {ϕ}_{\text{anode} \text{pH}}} + {\underbrace{\frac{R T}{n F} ln \left(\frac{{p}_{{\text{N}}_{2} , \text{bulk}}}{{p}_{{N}_{2} , \text{cathode}}}\right)}}_{\text{Δ} {ϕ}_{\text{cathode} {\text{N}}_{2}}}\end{matrix} \qquad \text{(2)}$$

where R is the gas constant, T is the temperature, n is the moles of electron transferred per mole of N₂, and p_{N₂} is the partial pressure of N₂. The losses given by equations (1) and (2) are due to transport of species in the electrolyte, which, in turn, depend on the applied current density, electrolyte composition, electrolyte hydrodynamics, N₂ feed concentration and rate, membrane composition, and catalyst selectivity. The kinetic overpotentials for the OER and NRR also contribute to the total losses in the electrochemical cell.

Transport of Species in the Electrolyte and Membrane: The transport of species in the electrolyte and membrane must satisfy mass conservation, such that

$$\frac{\partial {c}_{i}}{\partial t} + \frac{\partial {N}_{i}}{\partial x} = {R}_{i} \qquad \text{(3)}$$

where Nᵢ is the molar flux, and Rᵢ is the volumetric rate of formation of species i. The molar flux of species in dilute electrolyte can be written as a sum of fluxes due to diffusion and migration.

$${N}_{i} = - {D}_{i} \frac{\partial {c}_{i}}{\partial x} - {z}_{i} {u}_{i} F {c}_{i} \frac{\partial {ϕ}_{l}}{\partial x} \qquad \text{(4)}$$

where uᵢ is the mobility of ion given by the Nernst-Einstein relationship, and ϕₗ is the electrolyte potential. The diffusion coefficients of species in the dilute electrolyte are given below. The variation of diffusion coefficients with the electrolyte concentration was neglected, as the variation is marginal for dilute electrolytes (<< 10 mol%).

Diffusion coefficients of species in water at infinite dilution at 25° C.

| Species | Diffusion Coefficient (10⁻⁹ m² s⁻¹) | Mobility (10⁻⁷ m² V⁻¹ s⁻¹) |
|---|---|---|
| H⁺ | 9.311 | 3.626 |
| OH⁻ | 5.273 | 2.054 |
| K⁺ | 1.957 | 0.762 |

The electrolyte current density iₗ can be obtained from the total ionic flux,

$${i}_{l} = F {\sum }_{i} {z}_{i} {N}_{i} \qquad \text{(5)}$$

and the assumption of electro-neutrality,

$${\sum }_{i} {z}_{i} {c}_{i} = 0 \qquad \text{(6)}$$

The same set of Equations [(3)-(6)] were used to model the boundary layer region, the well-mixed region, and the membrane.

Well-Mixed Electrolyte: The well-mixed region of the electrolyte was assumed to have no diffusional resistance and therefore charged species are transported only by migration.

Membrane: The anion exchange membrane (AEM) such as Excellion was modeled as a solid electrolyte of 100 µm thickness with a fixed concentration of background positive charge of 1 M. The diffusion coefficients of anions and cations were reduced by a factor of 10 and by a factor of 100 (assumed), respectively, relative to those in the bulk liquid electrolyte.

Charge-Transfer Reactions at Anode and Cathode: The charge-transfer kinetics at the anode and cathode were modeled using the expression for Linearized Butler-Volmer kinetics, such as

$${i}_{s} = {i}_{l} = {i}_{R} = {i}_{0} \left(\frac{\left({α}_{a} + {α}_{c}\right) F}{R T}\right) η \qquad \text{(7)}$$

where iₛ is the electrode current density, i_{R} is the reaction current density, i₀ is the exchange-current density, and α is the transfer coefficient. The kinetic overpotential of a catalyst is given by η = ϕₛ -ϕₗ - E⁰ + Δϕ_{Nernstian}, where E⁰ is the equilibrium potential of the half-reaction at standard condition and, ϕₛ is the electrode potential.

The half-cell reaction at the Pt anode is the oxidation of water, which creates acidic conditions near the electrode.

$${\text{H}}_{2} \text{O} \to \frac{1}{2} {\text{O}}_{2} + 2 {\text{H}}^{+} + 2 {\text{e}}^{-} , {E}^{0} = 1.229 \text{V} \qquad \text{(8)}$$

The other half-cell reaction on Cu GDE cathode involves the reduction of water. Since the change in pH is influenced only by the concentration of OH⁻ ions, the NRR kinetics are not included at cathode. As shown below, the reaction occurs under alkaline conditions and, hence, can be written as:

$$2 {\text{H}}_{2} \text{O} + 2 {\text{e}}^{\text{-}} \to {\text{H}}_{2} + 2 {\text{OH}}^{-} {E}^{0} = 0 \text{V} \qquad \text{(9)}$$

The kinetic parameters for OER on Pt and HER on Cu are given below. Kinetic parameters for product-specific charge-transfer kinetics on Pt anode, Ag cathode

| Reaction Products | Catalyst | i₀ (mA cm⁻²) | α |
|---|---|---|---|
| O₂ | Pt | 0.27 | 0.500 |
| H₂ | Cu | 0.1 | 0.5 |

Electrode Current Density and Applied Potential: The current density at a metal electrode is given by Ohm’s law:

$${i}_{s} = - {κ}_{s} \frac{\partial {ϕ}_{s}}{\partial x} \qquad \text{(10)}$$

where κₛ is the conductivity of the electrode.

To maintain electroneutrality, the divergence of current density in the solid and the liquid must be zero:

$$\frac{\partial {i}_{l}}{\partial x} = 0 , \frac{\partial {i}_{s}}{\partial x} = 0 \qquad \text{(11)}$$

The potential in the electrochemical cell was calculated relative to the zero potential of electrolyte at cathode-electrolyte interface. The potential of anode (solid) was varied from 0.5 V to 5.5 V at a step of 0.5 V. Equations (1)-(11) were solved using COMSOL Multiphysics 5.4a to study the effect applied potential on pH at the cathode boundary.

Distribution of N2 and H2O Concentrations in the Electrochemical Cell and Bubbly Flow: The N₂ flow in the catholyte channel is modelled using a 2D transient, laminar, bubbly flow model. The N₂ flows perpendicular to the catholyte chamber from the right and leaves out from the top of the container.

Euler-Euler model is used to model the two-phase fluid flow. The two phases are treated as the interpenetrating media and the average concentration of the species is tracked. The following assumptions are made in the model. 1) The gas density is negligible compared to the liquid density. 2) The motion of the gas bubbles relative to the liquid is determined by the balance between the viscous drag and the pressure forces. 3) The two phases share the same pressure field.

$${ρ}_{l} {ϕ}_{l} \frac{\partial {u}_{l}}{\partial t} + {ρ}_{l} {ϕ}_{l} \left({u}_{l} . ∇\right) {u}_{l} = ∇ . \left[- p I + K\right] + {ρ}_{l} {ϕ}_{l} \text{g} \qquad \text{(12)}$$

Equation 12 shows the momentum balance where, uₗ is the velocity vector, p is the pressure, ϕ is the volume fraction, ρ is the density, g is the gravity vector. The subscripts l and g denote the liquid and the gas phases.

Gas flux is specified at the inlet and slip boundary condition is given for the liquid phase. The mass transport is modeled using two film theory. The mass transfer from the gas to liquid is given by,

$${m}_{g l} = k \left(C \text{*} - C\right) {M}_{g} \qquad \text{(13)}$$

where k shows the mass transfer co-efficient, C shows the dissolved concentration of gas in liquid, C* shows the equilibrium concentration of the dissolved gas in the liquid which is calculated by using the Henry’s constant given by equation 14:

$$C \text{*} = \frac{p + {p}_{r e f}}{H}$$

Transport of dilute species: The concentration of the dissolved N₂ in water is calculated using the chemical species transport equation. Equation 15 gives the species transport equation.

$$\frac{\partial {C}_{i}}{\partial t} + ∇ . {J}_{i} + u . ∇ {C}_{i} = {R}_{i} \qquad \text{(15)}$$

where Jᵢ = - Dᵢ ∇ Cᵢ, D is the diffusivity, C is the concentration, R is the reaction and the subscript i shows the species N₂.

$${R}_{i} = \frac{{m}_{i l}}{{M}_{i}} \qquad \text{(16)}$$

The mass transfer co-efficient is calculated from the Sherwood number correlation given by,

$${N}_{S h} = 2 + 0.4 {N}_{Re} {}^{0.5} {N}_{S c} {}^{1 / 3} \qquad \text{(17)}$$

No flux boundary conditions were imposed in all the walls. At the inlet of the cathode interface, N₂ consumption flux boundary condition is imposed. The N₂ consumption is experimentally determined by measuring the current density as a function of the flow rates. The equations 12 to 16 are solved in COMSOL to get the velocity distribution, gas phase volume fractions and the concentration of dissolved N₂ in the catholyte. The parameters used in the simulation are provided in the table below.

Parameters for the simulation of N₂ and H₂O concentrations in the catholyte cell:

| Parameter | Value | Unit |
|---|---|---|
| Henry’s Constant of N₂ | 1600 | (L.atm)/mol |
| Diffusion coefficient of N₂ | 2 × 10⁻⁹ | m²/s |
| Bubble diameter | 1 × 10⁻³ | m |
| Inlet gas volume fraction | 0.005 | |
| Density of N₂ | 1.27 | kg/m³ |

Distribution of N₂ and H₂O Concentrations in the GDE: The GDE is a porous electrode, it has a catalyst layer (hydrophilic) and the noncatalytic (hydrophobic) part. The catalyst part is completely wetted by water, the incoming N₂ forces the water out of the catalyst layer. Buckley-Leverett model is used to model the phase transport in the porous medium. The phase transport equation in the porous media is given by,

$$\frac{\partial {ε}_{p} {s}_{j}}{\partial t} + \frac{\partial }{\partial x} \left(\frac{{λ}_{1}}{{λ}_{1} + {λ}_{2}} u\right) = 0 \qquad \text{(18)}$$

where λⱼ = kᵣⱼ/µⱼ, kᵣ is the relative permeability given by

$${k}_{r j} = {s}_{j}^{2} .$$

εₚ is the porosity, λ is the relative permeability, s is the saturation and µ is the dynamic viscosity. The subscript j shows the corresponding phase. The resulting equation is solved in COMSOL to get the volume fractions for various flow rates.

Parameters for the simulations of water and Nitrogen distributions in GDE:

| | | |
|---|---|---|
| Parameter | Value | Unit |
| Porosity | 0.25 | |
| Permeability | 1 × 10⁻⁹ | m² |
| Viscosity of water | 0.001 | Pa.s |
| Viscosity of N2 | 1 × 10⁻⁵ | Pa.s |

### EXAMPLES

The following examples illustrate embodiments of the disclosure, but are not intended to be limiting.

### Example 1: Catalyst Screening

Density functional theory (DFT) calculations were performed to understand NiRR activity trends on various transition metals. The limiting potential activity volcanos were calculated for electrochemical NiRR and the hydrogen evolution reaction (HER) across a variety of transition metals, including Fe, Ru, Rh, Co, Ni, Zn, Pt, Pd, and Cu. The thermodynamic calculations for a series of nine elementary surface reactions involved in NO₃⁻ reduction to NH₃ show that the two most challenging steps form the strong and weak binding legs of the volcano. The calculations show that Co and Ni are most likely to be active, appearing very close to the peak of the electrochemical nitrate reduction volcano, wherein the catalysts further down the right leg of the volcano, such as Pt and Pd, are likely to be more active towards HER. For this reason, Co and Ni were tested experimentally, along with Cu and Fe, to explore the right and left legs of the volcano, respectively. Although near the peak of the HER volcano, Zn was also investigated experimentally due to its earth abundance.

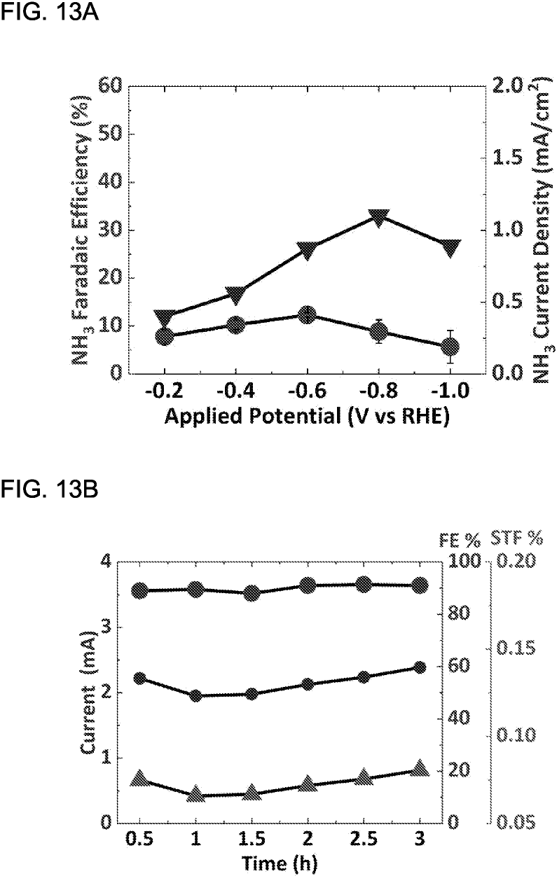

The activity and selectivity of Fe, Co, Ni, Cu, and Zn were confirmed experimentally in 1 M KNO₃ electrolyte of pH 7 at -0.8 V vs. RHE. The results are shown in FIGS. 13A-13C.

FIG. 13A shows the FE and current density of these catalysts. Co shows the highest NH₃ FE of 93.5% and NH₃ current density of 298 mA/cm². Cu and Zn did not show significant FE and current density. Although Fe and Ni showed higher FEs, their NH₃ current densities were lower as compared to Co.

Therefore, Co was chosen for further studies of NiRR. Next, the effectiveness of different substrates, namely polytetrafluoroethylene (PTFE), graphite, and Co metal plates, were evaluated as supports for Co.

FIG. 13B shows linear sweep voltammogram (LSV) for Co on PTFE (Co/PTFE), graphite planchet (blank GP), Co on GP (Co/GP), Co metal plate, and oxide-derived Co on Co metal plate (OD-Co) in 1 M KNO₃ of pH 7 at a sweep rate of 5 mV/s. Co sputter-coated on a high-surface-area PTFE membrane did not show any activity for NiRR. This could be due to the poor conductivity of Co films on PTFE. Co sputter-coated on the GP has a similar onset potential and current density as that of polycrystalline Co metal plate. The LSV of Co/GP is also compared with the blank GP as a control experiment.

To further improve the activity of Co metal, OD-Co was prepared by continuous oxidative and reduction cycles on Co metal surface (the detailed procedure is given in the Methods section). The improved performance of the OD-Co can be attributed to the higher surface roughness and the oxidation state of the Co.

FIG. 13C shows the LSVs normalized by the electrochemically active surface area (ECSA). The ECSA of Co metal plate and OD-Co were close, 10.600 cm² and 10.975 cm², respectively. Without wishing to be bound to any particular theory, it is believe that the higher specific activity of OD-Co can be attributed to increased surface roughness that were measured using atomic force microscopy (AFM). The maximum surface roughness depth of Co metal increases by ~100 nm in OD-Co. Also, the average roughness of Co increases from 7.3% to 20.4% for OD-Co. Table 1. Surface Analysis using Atomic Force Microscopy

| Catalyst | Max Surface Roughness (Rₘₐₓ) | Roughness Factor (RF) % |
|---|---|---|
| Co | 615 nm | 7.3 |
| OD-Co | 785 nm | 20.4 |

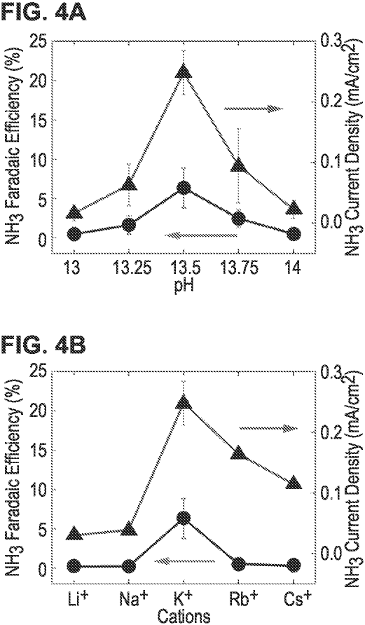

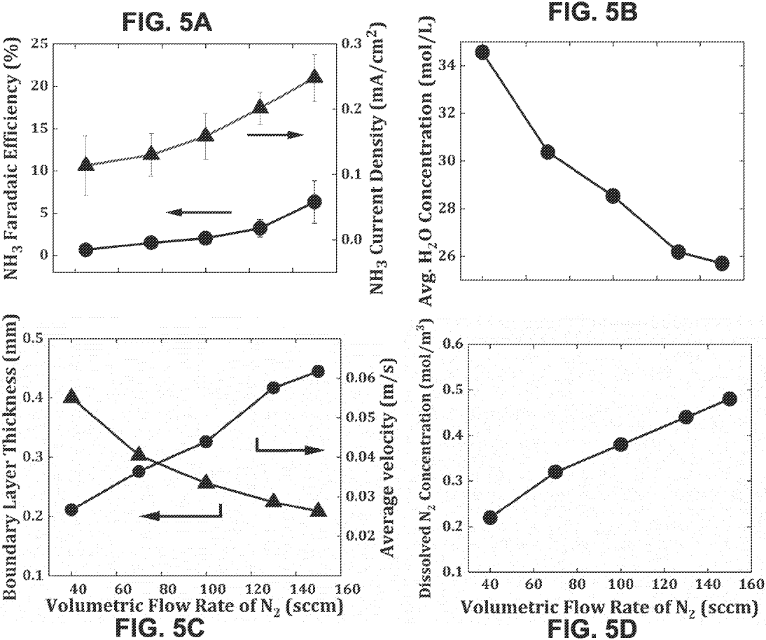

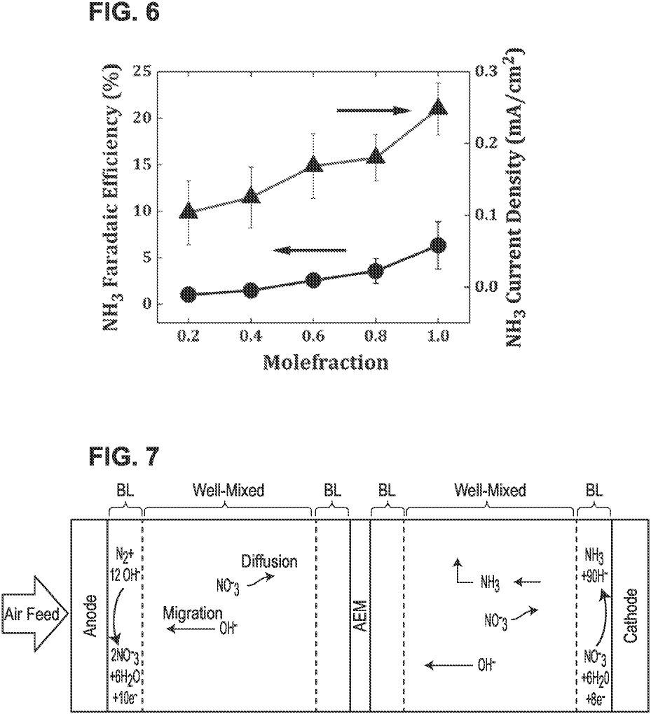

The effect of pH, applied potential, and concentration of NO₃⁻ on NH₃ FE and current density on OD-Co was evaluated. The results are shown in FIGS. 4A-4G.

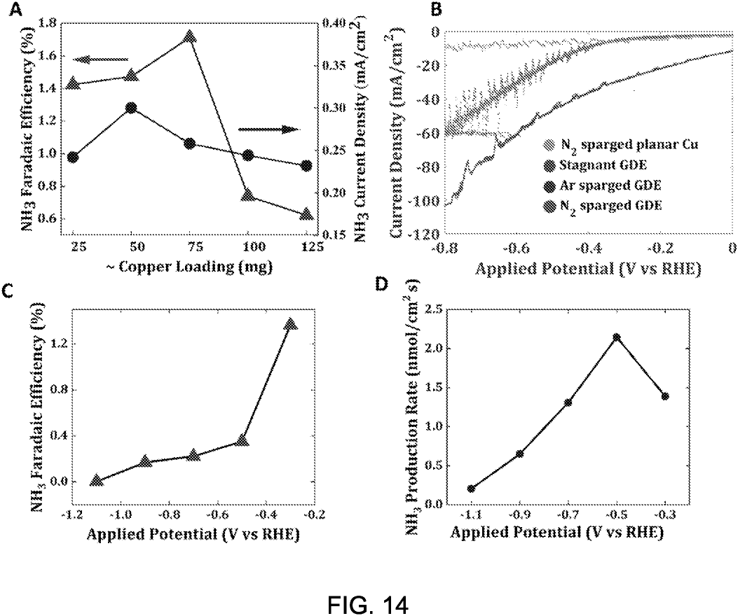

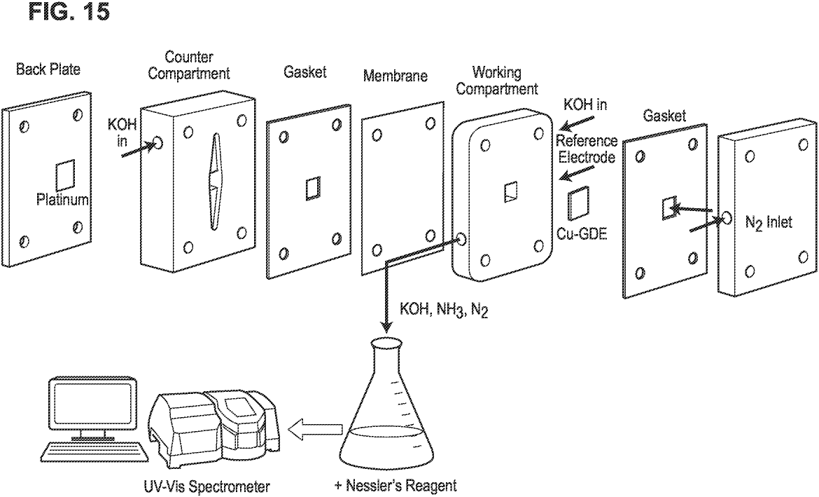

FIG. 14A shows the NH₃ FE and current densities at -0.6 V vs. RHE for 1 M NO₃⁻ electrolyte of pH 1, 7, and 14. While FEs do not vary significantly with increasing pH, the NH₃ current densities increase almost linearly. The lowest activity is observed in acidic medium, which could be due to lowered binding energy of NO₃⁻. The maximum NH₃ FE (90.95 %) and NH₃ current density (372 mA/cm²) are obtained at pH 14. The effect of applied potential on the FE and current density is then investigated in a neutral and alkaline medium.

FIG. 14B shows the NH₃ FE and current density as a function of applied potential at pH 14. As the negative potential bias is increased, the NH₃ current density increases monotonically past the onset potential of 0.1 V vs. RHE. The calculated Tafel slope is 169.3 mV/dec. The FE increases sharply and reaches a plateau around 92% at negative potentials higher than -0.2 V vs. RHE. The lower FE at the onset potential can be due to the reduction of CoOₓ. The maximum NH₃ current density 565±24 mA/cm² and a turnover frequency (TOF) 6.35 × 10⁶ h⁻¹ (highest so far) are obtained at -0.8 V vs. RHE.

FIG. 14C shows the NH₃ FE and current density as a function of applied potential at pH 7. The current density vs. potential curve at pH 7 is shifted more negative to about 0.2 V for the pH 14 curve (note that the x-axis scale is different in FIGS. 14B and 14C). The onset potential for NO₃⁻ reduction is also increased in a neutral pH medium. The kinetics of NiRR in neutral pH is relevant to the removal of NO₃⁻ from the municipal wastewater, where the concentration of NO₃⁻ is in the range 1-3 mM.

FIG. 14D shows the almost linear (1^{st} order with R² = 0.96) variation of NH₃ current density with respect to NO₃⁻ concentration in the range 0.1 M to 1 M. The NH₃ current density varies non-linearly below 0.1 M due to mass transfer limitations. OD-Co is selective with >80% FE over a wide range of NO₃⁻ concentrations from 10 mM to 1 M. The FE and NH₃ current density versus applied potential with simulated wastewater is also shown in FIG. S15 of the Supporting Information. Maximum NH₃ current density of 0.89 mA/cm² and FE of 12.34 % are obtained using simulated wastewater. Stability studies are performed for a period of 24 h on OD-Co at -0.4 V vs. RHE at pH 14.

FIG. 14E shows the total current density as a function of time. The OD-Co remained stable for the entire duration of 24 h in alkaline conditions and the NH₃ FE for the overall 24 h run was 86.76 %.

FIG. 14F compares the NH₃ FE and geometric-area-normalized current densities reported in the literature with the current study.

FIG. 14G compares the NH₃ FE and active-area-normalized current densities (specific activity) reported in the literature with the current study.

### Example 2: Electrode Preparation and Characterization

The metals were mechanically polished before every experiment using a 600-Grit SiC sandpaper for 2 minutes and washed using isopropyl alcohol, tap water, and deionized water. Co/PTFE and Co/GP were prepared by sputter coating Co on the PTFE membrane and graphite planchet (GP). The thickness of the sputter-coated Co is 10 nm. Oxide-derived cobalt (OD-Co) was prepared by the following procedure: Co was first polished and cleaned by the previously mentioned procedure. Oxidative-Reductive cycles were carried out by using cyclic voltammetry (CV). 1 M KOH was used as the electrolyte, platinum was used as the counter electrode and Ag/AgCI/KCI was used as the reference electrode. The CV was carried out between -2 to 2 V vs. Ag/AgCl at 500 mV/s scan rate and 100 cycles were performed. The resulting OD-Co was washed using deionized water and oven-dried at 85° C. The above-mentioned procedure was carried out before every experiment when OD-Co was involved.

X-Ray Diffraction (XRD): X-Ray diffraction measurements were performed using Cu Kα radiation produced at 40 kV and 40 mA (Bruker D8 ADVANCE) to analyze the bulk crystal structure of the OD-Co. The measurement errors were mitigated from the surface curvature by using a diffractometer equipped with parallel beam optics and a 0.5° slit analyzer.

X-Ray Photoelectron Spectroscopy (XPS): XPS measurements were performed using a monochromatized Al Kα radiation produced at 12 kV and 10 mA (Kratos Axis-165) to analyze the near-surface composition and the oxidation state of the oxide-derived Cobalt before and after electrolysis. Ar sputtering was not performed on the sample surface to prevent the composition changes. A survey scan was performed followed by the high-resolution scans between the binding energies 770 and 810 eV to identify the Co 2p peaks. The binding energy of the measured core level spectra was calibrated by setting the observed C 1 s binding energy to 284.8 eV.

Operando Attenuated Total Reflection Surface-Enhanced Infrared Spectroscopy (ATR-SEIRAS): ATR-SEIRAS was performed (Bruker Invenio S FTIR spectrometer) to get insight into the nitrate reduction mechanism. A custom-made electrochemical cell with a 60° Ge face-angled crystal was used on a VeeMax III variable angle accessory. To enhance the metal wettability of the Ge crystal, it was sputter-coated with an IR transparent indium tin oxide (ITO) to form a 53 nm thick ITO layer using a film thickness monitored sputtering (EMS Quorum 150TS plus). Co was sputtered on top of this ITO layer with a thickness of 13 nm. The spectra were acquired at 3 potentials - below the onset potential (0.1 V vs. RHE), above the onset potential (-0.3 V vs. RHE), and near the maximum FE of NH₃ production (-1 V vs. RHE). Each spectrum was acquired with a resolution of 2 cm⁻¹ using a liquid N₂ cooled mid-band mercury cadmium telluride (MCT) detector and averaged over 64 scans.

### Example 3: Electrochemical Measurements

All electrochemical experiments were performed in a three-electrode H-cell configuration (Biologic SP300 potentiostat and EC-Lab V11.012 workstation) with constant stirring at 750 rpm using a magnetic stirrer at ambient conditions. Applied Potential was represented in the reversible hydrogen electrode (RHE) scale using the following equation:

$$\text{E} \left(\text{V} \text{vs} \text{RHE}\right) = \text{E} \left(\text{V} \text{vs} \text{Ag} / \text{AgCl} / \text{KCl}\right) + 0.059 \times \text{pH} + 0.205 \qquad \text{(1)}$$

The catholyte and the anolyte chambers were separated by using a quaternary ammonium anion exchange membrane. The membrane was priorly hydrated in distilled water for 48 h at 85° C. For the electrolyte with pH 1, a Nafion membrane was used. The ohmic resistance was measured at the open circuit potential by performing electrochemical impedance spectroscopy (EIS) from 30 kHz to 1 Hz before all the experiments and fitted using EC-Laboratory with 100 % IR-drop compensation. 1 M KNO₃ was used as the electrolyte for the LSV studies with a potential scan rate of 5 mV/s. Effect of pH studies was performed at three different pH conditions (1, 7, and 14). 1 M KNO₃ was prepared in 0.1 M HNO₃ solution to maintain the pH at 1. Phosphate buffer was used to maintain 1 M KNO₃ solution at pH 7. Phosphate buffer was prepared by using 0.62 M phosphate monobasic solution and 0.38 M phosphate dibasic solution. pH 14 was maintained by preparing 1 M KNO₃ solution in 1 M KOH solution. All other experiments were performed using 1 M KNO₃ at pH 14. Simulated wastewater was prepared by adding 26 mg/L KNO₃, 26 mg/L KNO₂, 580 mg/L KCI, 102 mg/L K₂SO₄, and 366 mg/L KHCO₃.

Ammonia Quantification: Ammonia present in the electrolyte solution was quantified by the Indophenol method. A 3 mL of the sample was used for quantification. 500 µL of phenol nitroprusside solution and 500 µL of alkaline hypochlorite solution were added to the sample. The resulting solution was incubated at room temperature for 30 min in the dark. The colorless solution containing ammonia turns to indigo-blue color when the above-mentioned reagents are added. After 30 min, the samples were analyzed using a Visible Spectrophotometer (Genesys 30), and spectra were obtained between the wavelengths 400 and 800 nm. The maximum absorbance was obtained at 632 nm. Separate calibration graphs were prepared for pH 1, 7, and 14. For the samples with pH 1, 1 mL of the sample was mixed with 2 mL of 1 M KOH and then the analysis was performed.

Control Studies: All the experiments were repeated thrice, and the average values were reported with standard deviations. All glassware, vials, and electrochemical cell parts were washed thrice using running water, deionized water, and oven-dried at 85° C. before usage to avoid overestimation, from the contamination of NH₃ from adverse sources (air, reagents, etc.). Premeasurements were done to test for ammonia before every experiment and the concentration of NH₃ measured was subtracted from the post measurement. The concentration of NH₃ measured during the start of the experiment was usually very less. Open circuit experiments were conducted thrice, and the ammonia measured was not in the detectable limits, which indicates that it is from some contamination source and the NH₃ produced during the closed-circuit experiments was solely from the electrochemical reduction of nitrates. The concentration of NH₃ measured during the electrochemical reduction of nitrates is greater than 50 mM, and hence the N¹⁵ isotope labeling experiments were not needed to confirm the source of NH₃.

### Example 4: Solar-Driven Ammonia Production

This example demonstrates an efficient integration of GalnP/GaAs/Ge triple-junction solar cell (Spectrolabs) with an electrochemical cell consisting of oxide-derived Co (OD-Co) for NO₃⁻ reduction reaction (NiRR) and Ni foam for oxygen evolution reaction (OER) to achieve greater than 10% STF efficiency for NH₃ production, in accordance with principles of the disclosure. The active catalyst OD-Co shows a high activity and selectivity of NiRR with an onset potential of 0.1 V vs. RHE, maximum FE of 92±6%, an active-area-normalized current density of 14.56 mA/cm², and geometric current density of 565 mA/cm².

The j-V characteristics curve was obtained by doing a potential sweep at a rate of 10 mV/s between 0 and 3 V. Comparison was made between illumination using ambient light and AM 1.5 G. Power was calculated by multiplying the absolute value of the current with the applied potential. The parameters obtained from the solar cell characterization are shown in Table X.

TABLE 2

Solar Cell Characterization Parameters

| Parameter | Value |
|---|---|
| Area illuminated | 16 cm² |
| Open circuit potential (E_{oc}) | 2.50127 V |
| Short circuit current (I_{sc}) | 463.08 mA |
| Theoretical maximum power | 1158.288 mW |
| Maximum potential (Eₘₐₓ) | 1.70664 V |
| Maximum current (Iₘₐₓ) | 438.998 mA |
| Maximum power (Pₘₐₓ) | 749.2115 mW |
| Power input (Pᵢₙ) | 100 mW/cm² |
| Fill Factor (FF) | 0.6468 |
| Efficiency (η) | 46.83 % |

The total area of the solar cell illuminated by using simulated AM 1.5 G sunlight was 16 cm². Open circuit potential (Eoc) is the potential at which the current is 0 and short circuit current (Isc) is the current at which the potential is 0. Theoretical maximum power is the product between Isc and Eoc. Maximum power (Pₘₐₓ) obtained from the solar cell is found from the power-voltage curve and the current corresponding to that is the maximum current (Iₘₐₓ) and the potential corresponding to that is the maximum potential (Eₘₐₓ). Fill Factor (FF) is the ratio between the maximum power obtained from the solar cell and the theoretical maximum power. The efficiency of the solar cell is defined as the ratio between the maximum power obtained from the solar cell and the power input to the solar cell (AM 1.5 G - 1 Sun is 100 mW/cm²). The open-circuit current was measured as a function of time by using the potentiostat as a zero-resistance ammeter.

The solar cell was irradiated using Oriel LCS -100 Solar simulator to simulate AM 1.5 G. The power input to the solar cell is 100 mW/cm². The total area of the solar cell being irradiated was 16 cm². A membrane-free configuration was used to reduce NO₃⁻ to NH₃. Ni foam was used as the anode and OD-Co was used as the cathode. The surface area of the OD-Co was approximately 8 cm². The copper tape was used as the current collector. The current flowing through the circuit was measured by using a potentiostat as a zero-resistance ammeter. The solar to fuel efficiency (STF) was calculated based on the following equation:

$$S T F = \frac{{j}_{N {H}_{3}} . {A}_{e l e c t r o d e} . {E}^{o}}{{P}_{i n} . {A}_{s o l a r c e l l}} \times 100$$

where, J_{NH₃} is the ammonia current density (mA/cm²), A_{electrode} is the electrode area (8 cm²), E^{o} is the equilibrium cell potential (1.23 V - 0.69 V = 0.54 V). Here, the equilibrium potential for OER occurring at the anode is 1.23 V vs. SHE and the equilibrium potential for NiRR occurring at cathode is 0.69 V vs. SHE.

Solar-to-Fuel (STF) Efficiency for Ammonia Production. Solar-driven NO₃⁻ reduction to NH₃ was evaluated by connecting a Spectro lab’s XTJ (GalnP/GaAs/Ge) triple Junction solar cell to the electrochemical cell (see photovoltaic (PV)-electrolyzer configuration in FIG. 15A). The measured power efficiency of solar cell was measured to be 46.83%. 16 cm² of solar cell is irradiated under an AM 1.5G using a Solar simulator (Newport LCS 100) and the reaction was carried out for 3 h, as shown in FIG. 15A.

FIG. 15B shows the intersection of the current vs. cell voltage (JV curve) of the solar cell with the current vs. cell voltage (load curve) of the electrochemical cell. The PV-electrolyzer cell has an operating current of about 300 mA and an operating cell voltage of about 2 V.

FIG. 15C shows the total current, NH₃ FE, and STF efficiency obtained over 3 h in a PV-electrolyzer cell. A stable current of about 300 mA, FE of 95%, and STF efficiency of 11% was obtained in the PV-electrolyzer cell with a cell voltage of about 2 V without external bias. This PV-electrolyzer cell was also demonstrated for conversion of NO₃⁻ in simulated wastewater (containing only 3 mM NO₃⁻) to NH₃ at STF efficiency ~0.25%. Simulated wastewater was prepared with the following composition (3 mM nitrates, nitrites, carbonates, bicarbonates, phosphates, sulphates) and the pH was maintained at 8.5. NH₃ current density and NH₃ Faradaic efficiency were measured by varying the applied potentials. A maximum NH₃ Faradaic efficiency of approximately 12% and an NH₃ current density of approximately 1 mA/cm² were obtained. See FIGS. 16A-B.

Solar-driven electrosynthesis of NH₃ has been extremely challenging due to the unavailability of highly selective and active catalysts and the inefficient integration of solar cells with electrolyzers. The maximum reported STF efficiency for NH₃ is less than 1%. In this work, we develop a novel catalyst, optimal electrolyte composition, and efficient PV-electrolyzer integration to achieve approximately 11% STF efficiency at ambient conditions. In summary, theoretical and experimental screening of late transition metals for the electrochemical reduction of NO₃⁻ to NH₃ determine Co as a better catalyst for NiRR. The highest efficiency towards NiRR is obtained with Co, whose activity is limited by protonation of adsorbed NO₂ to form NO₂H. The activity of Co has improved at least four folds by increasing surface roughness. The oxide-derived (OD) Co has the highest specific activity among all the catalysts reported in the literature, with a maximum NH₃ current density of approximately 565 mA/cm² and FE approximately 92%. The OD-Co is also active in neutral pH conditions with 1st order rate dependence with respect to NO₃⁻. This enables OD-Co to selectively reduce NO₃⁻ in wastewater to NH₃. An efficient PV-electrolyzer cell consisting of GalnP/GaAs/Ge solar cell connected with an electrochemical cell is developed. A stable solar to NH₃ efficiency of 11% is obtained at 1 sun and ambient conditions. The specific current density and STF efficiency reported in this work is, to our knowledge, the highest in the literature, indicating that solar-driven electrochemical synthesis of NH₃ via NO₃⁻ is a feasible route for the renewable synthesis of NH₃.

### Example 5

The GDE was prepared by electrodepositing Cu on a hydrophobic carbon paper (Fuel cell store). Copper was electrodeposited on porous carbon paper by applying an applied potential of -2 V vs Ag/AgCl using Chronoamperometry for a period of 15 minutes. 0.5 M CuSO₄ with a pH of 1.23 regulated by adding 500 µL of fuming HNO₃ was used as the electrolyte. The catalyst loading was 75 mg which was found by measuring the weights of the carbon paper before and after the experiments. The resulting electrode, Copper deposited on the porous carbon paper is the Gas Diffusion Electrode (GDE). The Cu-GDE was stuck to the catholyte side of the electrochemical and the copper tape is used as a current collector. N₂ passes through the GDE and its hydrophobic nature prevents the back diffusion of the electrolyte. Platinum was used as the counter electrode. It was mechanically polished before the experiments.

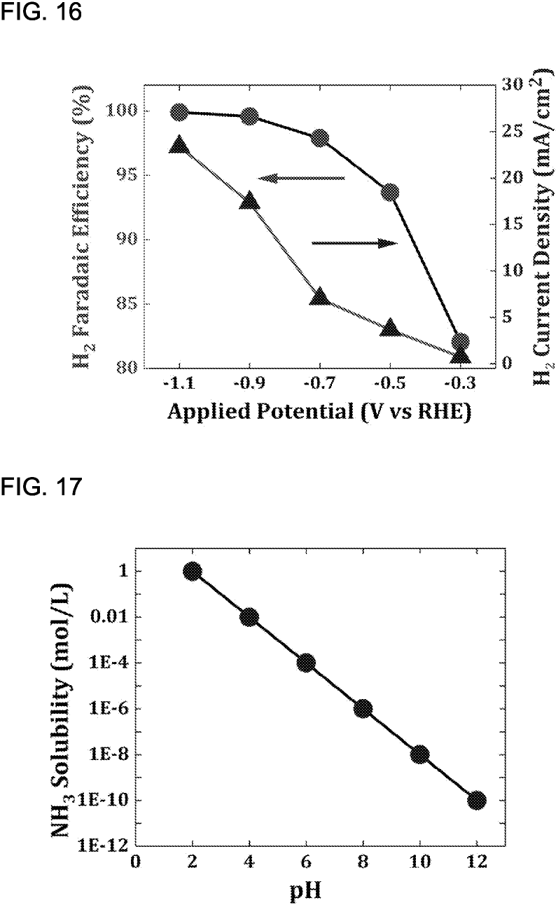

The electrodeposition was conducted on a 2×3 cm carbon paper immersed in a 0.5 M Cu(NO₃)₂ (Sigma Aldrich, 99.999%) at -2 V vs. Ag/AgCl (innovative instruments) for 15 minutes. The uniformity of deposition and morphology of Cu crystals was confirmed using scanning electron microscopy (SEM, Hitachi S-4800 SEM) images taken before and after NRR experiments. The elemental composition of the Cu-coated carbon paper was obtained using x-ray photoelectron spectroscopy (XPS, Thermo Scientific ESCALAB 250 Xi). The crystalline structure of Cu deposited on carbon paper was analyzed using grazing incidence x-ray diffraction (GI-XRD, Bruker Discover 8 X-Ray Diffraction System). Polycrystalline platinum plate (ACI Alloys, 99.999%) of 1.5 cm x 1.5 cm area was polished using alumina suspension and cleaned before using as the counter electrode. The results are shown in FIGS. 17A-D.

Field Emission Scanning Electron Microscopy (FESEM) was performed on carbon paper, the pre, and post NRR catalyst samples on Hitachi S-4800 FESEM. All the scans for the different samples were done at similar working distances, magnifications, and accelerating voltage varying from 2 kV to 10 kV from lower to higher magnification respectively. The layer of Cu deposited was seen in both pre and post NRR samples. The depth in the images showed heavy surface deposition of Cu. Even though the pre and post NRR samples looked almost identical, the pre NRR sample had more agglomerated Cu deposited whereas the individual Cu rods could be seen clearly in the post NRR sample.

X-Ray Photoelectron Spectroscopy (XPS) was done in order to identify the oxidation state of the Cu GDE electrocatalyst. XPS analysis was done for the same three samples (Carbon paper, pre NRR Cu GDE, post-NRR Cu GDE) on Thermo Scientific ESCALAB 250 Xi.

All spectra were acquired using monochromatized Al K_{α} X-ray energy of 1486.6 eV. Argon sputtering of the sample surface was avoided to prevent any surface composition changes. The binding energy of the measured core level spectra was subjected to drift correction by using C 1 s peak at 284.8 eV as the reference.

An alkaline electrolyte was used in NRR experiments to minimize H₂ production and to promote NH₃ formation. The electrolyte was prepared using KOH (BioXtra, ≥85% KOH basis) in the pH range 13 to 14. For the study on the effect of cation type, electrolytes containing LiOH, NaOH, RbOH, and CsOH (Sigma Aldrich, all chemicals of purity ≥98%) of pH 13.5 were prepared separately.

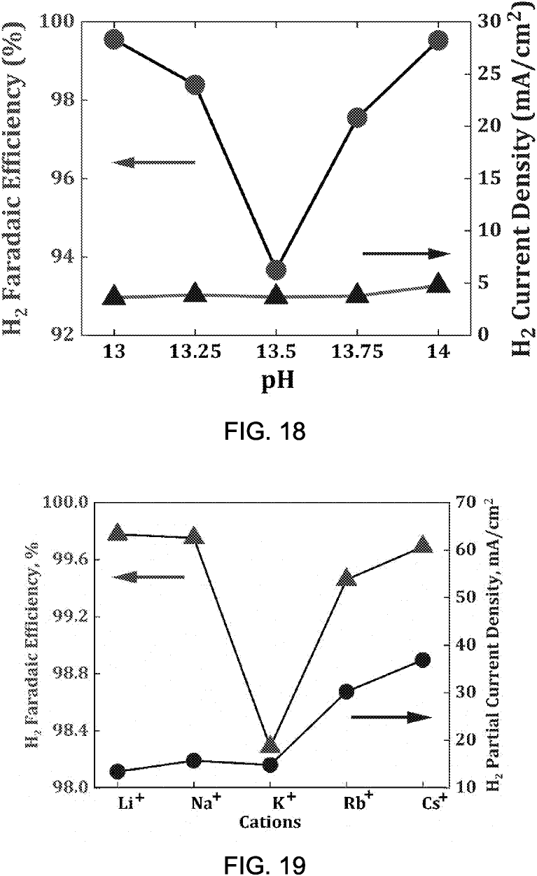

The electrochemical measurements of NRR were carried out in a custom-made, closed-loop, flow-through GDE cell using a Biologic SP-300 potentiostat at ambient pressure conditions. The exposed surface areas for both working and counter electrodes were 1 cm², the volume of the anolyte and catholyte was 5 ml each, and the reservoir volume was approximately 30 ml. The N₂ gas (Praxair, >99.998%) was sparged through GDE at 150 sccm, and the electrolyte was recirculated at 5 mlpm. Quaternary ammonium, anion exchange membrane (AEM, Exellion) was used to minimize product crossover while allowing OH⁻ conductivity. The NH₃ produced at the cathode interface can redistribute in the electrolyte and gas bubbles, as it is a highly volatile compound with Henry’s constant of ~29 mol liter⁻¹ atm⁻¹. Therefore, the unreacted N₂ and the product gases were swept through an acidic chamber of 0.1 M H₂SO₄ (Sigma Aldrich, >99.999%) for NH_{3(g)} absorption and subsequent quantification using Nessler’s reagent (Online Science Mall). NH₃ dissolved in the liquid electrolyte was also quantified using Nessler’s reagent for the total measurement of NH₃ produced in NRR. As a cost-effective alternative to N₂ isotope tests, several control measurements were conducted to confirm NH₃ synthesis from NRR. FIG. 18 shows a schematic of the experimental setup and the detailed design of the flow-through GDE electrochemical cell, respectively.

Several control measurements were conducted to confirm the synthesis of NH₃ from the electrochemical reduction of N₂. There can be two primary external sources of NH₃ contamination that can affect the experimental measurements- i) the trace amount of copper nitrate from electrodeposition can contribute to NH₃ synthesis, and ii) NH₃ present in the trace levels in the compressed N₂ cylinder. The other minor external sources of NH₃ could be air, membrane, chassis, tubings, and nitrile gloves. The following measures were taken to reduce NH₃ contamination. The Cu-coated GDE was washed with DI water, IPA, and electrolyte, followed by cyclic voltammetry to get rid of any nitrate impurity from the electrode. The removal of N impurity was confirmed by XPS analysis. The N₂ used in all the experiments had only two reported impurities- 5 ppm of O₂ and 3 ppm of H₂O (source: Praxair NI 4.8T). The N₂ was purified in a multi-bed purifier (source: Vici Metronics) before passing through the GDE, which further increased its purity to at least 99.9999%. It was confirmed <0.001 mA cm⁻² of NH₃ when N₂ was sparged for 1 h at open circuit potential and that no detectable amount of NH₃ when Ar was sparged at higher negative potentials. These two findings confirm that the source of nitrogen in all NRR experiments is exclusively N₂. This proposed method to verify the origin of N in NRR is significantly cost-effective as compared to the N₂ isotope labeling experiments.

Temperature and Pressure were maintained at ambient conditions. NRR experiments were carried out using Chronamperometry (CA) for a period of 1 h. The solution resistance was found using Potentio Electrochemical Impedence Spectroscopy (PEIS) at open circuit voltage by varying the frequency from 100 kHz to 30 Hz. 10 measurements were taken per frequency and the experiment was repeated once. 100 % of the resistance was compensated in situ.

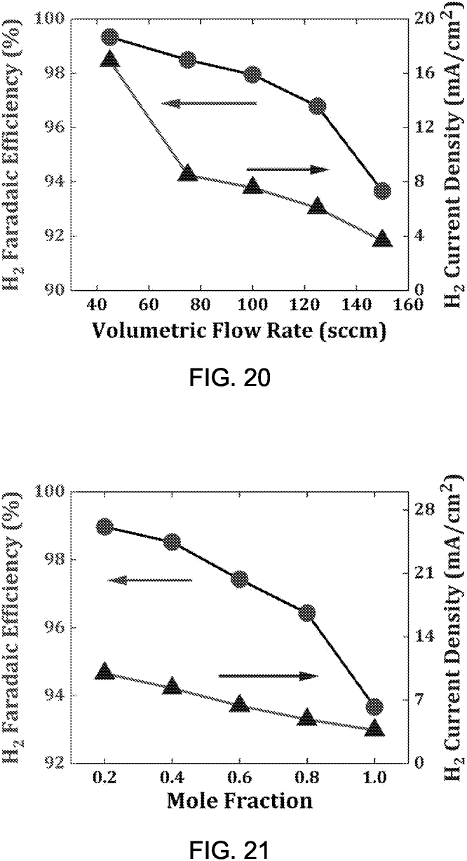

The conditions in Tables 3-5 were used for experiments as the applied potential, pH, and cation was varied. The results are shown in FIGS. 19-21.

TABLE 3

Experimental Conditions for Varying Applied Potential

| | |
|---|---|
| Parameter | Value |
| pH | 13.5 |
| N₂ Gas Flow Rate | 150 sccm |
| Liquid Electrolyte Flow Rate | 5 mL/min |
| pH Regulator | KOH |
| Applied Potential | 0 to -0.8 V vs RHE |

TABLE 4

Experimental Conditions for Varying pH

| | |
|---|---|
| Parameter | Value |
| pH | 13, 13.25, 13.5, 13.75, 14 |
| N₂ Gas Flow Rate | 150 sccm |
| Liquid Electrolyte Flow Rate | 5 mL/min |
| pH Regulator | KOH |
| Applied Potential | -0.5 V vs RHE |

TABLE 5

Experimental Conditions for Varying the Cation

| | |
|---|---|
| Parameter | Value |
| pH | 13.5 |
| N₂ Gas Flow Rate | 150 sccm |
| Liquid Electrolyte Flow Rate | 5 ml/min |
| pH Regulator | LiOH, KOH, NaOH, RbOH, CsOH |
| Applied Potential | -0.5 V vs RHE |

The decrease in the FE and current density of NH3 for pH > 13.5 can be due to - i) increase in the surface coverage of H-atom attributed to increasing H binding energy3 that causes a decrease in the number of sites available for N2 binding leading to lower NRR rates, and ii) re-organization of H2O from H-down to O-down state near the cathode due to increasing concentration of OH-1 that reduces the activation barrier of HER2 and promotes HER.

While the HER current density does not change significantly with increasing size of cation from Li⁺ to K⁺, the NRR current density increases sharply from Na⁺ to K⁺. This promotional effect due to an increase in the size of cations is attributed to a decrease in the hydration number of cations that allows for an increase in their concentrations in the outer Helmholtz plane and thereby an increase in the local electric field, which helps in adsorption of polar adsorbates.^{4,5}. Since adsorbed H does not have a dipole moment, its binding energy and, therefore, the rates of HER are not affected by the cation-induced electric field. However, this cation-induced electric field can increase the binding energy of polar intermediates- NHₓ (x = 1, 2, and 3) and thus the NRR rates.

The conditions in Table 6 were used for experiments as the flow rate was varied. The results are shown in FIG. 23.

TABLE 6

Experimental Conditions for Varying the Flow Rate

| | |
|---|---|
| Parameter | Value |
| pH | 13.5 |
| N₂ Gas Flow Rate | 50, 75, 100, 125 and 150 sccm |
| Liquid Electrolyte Flow Rate | 5 ml/min |
| pH Regulator | KOH |
| Applied Potential | -0.5 V vs RHE |

The conditions in table 7 were used for the experiments and the partial pressure of N2 was varied by mixing N2 with Ar. See FIG. 24.

TABLE 7

Experimental Conditions for partial pressure experiments

| Parameter | | Value |
|---|---|---|
| pH | | 13.5 |
| Liquid Electrolyte Flow Rate | | 5 ml/min |
| pH Regulator | | KOH |
| Applied Potential | | -0.5 V vs RHE |
| Mole Fraction | Gas Flow Rate | |
| | N₂ (sccm) | Ar (sccm) |
| 0.2 | 30 | 120 |
| 0.4 | 60 | 90 |
| 0.6 | 90 | 60 |
| 0.8 | 120 | 30 |
| 1 | 150 | 0 |

Energy Consumption: The power required is calculated by multiplying the applied voltage and NH₃ current density. The energy consumption per kg of NH₃ is calculated by dividing the power required with the production rate of NH₃. The total energy consumption is 20.4 MJ/kg. Table 8 denotes the parameters used for the energy calculations.

TABLE 8

Parameters for energy consumption studies

| | |
|---|---|
| Current Density Required | 0.2483 mA/cm² |
| Half Cell Potential Required | 1.501 V |
| Total Cell Potential Required (Including the counter cell potential) | 3.001 V |
| Total Cell Power Required | 7.449 W/m² |
| NH₃ Produced | 0.207 kg/(m² day) |
| Total Cell Energy Consumption | 20.4 MJ/kg |

Partial Current Density: The ammonia partial current density (A/cm²) is found as,

$${j}_{N {H}_{3}} = \frac{{C}_{N {H}_{3}} V . F . n}{t . A}$$

$${j}_{N {H}_{3}} = \frac{{C}_{N {H}_{3}} V . F . n}{t . A}$$

where C_{NH₃} is the concentration of Ammonia (mol/m³), V is the Volume of the sample (m³), F is the Faraday constant (96485 C/mol), n is the number of electrons required for ammonia synthesis (3), t is the time of experimental run (s) and A is the electrode area (cm²).

Ammonia Production rate (mol/cm²s) is found as,

$${F}_{N {H}_{3}} = \frac{{C}_{N {H}_{3}} V}{t . A}$$

Faradaic Efficiency: Ammonia Faradaic Efficiency (%) is determined as,

$${F}_{N {H}_{3}} = \frac{{j}_{N {H}_{3}}}{{j}_{T}} .100$$

where j_{NH₃} is the ammonia partial current density (A/cm²) and j_{T} is the total current density (A/cm²).

Electrochemical Active Surface Area: Cyclic Voltammetry was performed at a different scan rates from -0.1 V to 0.1 V at an open circuit potential. A 10 second hold time was held at both the ends. The oxidation and the reduction currents were measured for the different scan rates. The scan rates were plotted as a function of the absolute difference between the oxidation and the reduction currents. The slope was found to be 0.1991 mV. ECSA was found by dividing the slope with the specific capacitance which is 0.0375 mF/cm². The ECSA was found to be 5.309 cm².

Ammonia Quantification. The UV-Visible spectroscopic analysis was performed at 400 nm. Ammonia solutions of different concentrations 1 ppm, 2 ppm, 3 ppm, 4 ppm and 5 ppm in 13.5 pH KOH solution were prepared to mimic the catholyte solution. Nessler’s reagent changes the color of the solution from colorless to different shades of yellowish orange depending on the concentration of ammonia. Absorbance was found for all the cases and linear regression was performed. The unknown sample concentration was found from the calibration curve. The calibration curve experiments were performed separately when the pH of the solution and the cations were changed.

Control Experiments. Stringent measures were undertaken to prevent the NH₃ contamination from various sources (incoming N₂ feed, reagents, electrochemical cell, catalyst, and vials used to collect product) and to ensure that the source of NH₃ is from electrochemical N₂ reduction.

The incoming N₂ (99.999% pure) is passed through a container containing 0.5 M H₂SO₄ followed by a container containing 1 M KOH to remove any trace impurities such as NH₃ and NOx before entering the electrochemical cell. All the beakers and the containers were thoroughly washed using tap water followed by 0.5 M H₂SO₄ followed by tap water followed by IPA followed by tap water and finally using DI water. They are oven dried at 70° C. before using for experiments.

Ar saturated experiments were performed at different potentials and NH₃ detected was very negligible. Open circuit N₂ reduction experiments were performed and the NH₃ detected was very negligible.

Before starting the experiments, the electrolyte was flowed through the electrochemical cell for 10 minutes, the resulting solution was tested for NH₃. The negligible concentration of NH₃ obtained from the pre run was subtracted from the final concentration of NH₃ obtained after the electrochemical NRR experiments to reduce the error in reporting.

In addition to that, all the experiments were repeated thrice and reported with the error bar. The following figure shows the NH₃ current density obtained during several control experiments and the obtained ones are negligible compared to the ones obtained when the potential is maintained at -0.5 V vs RHE while sparging N₂, there by indicating that the source of NH₃ is N₂.

Because other modifications and changes varied to fit particular operating requirements and environments will be apparent to those skilled in the art, the disclosure is not considered limited to the example(s) chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed:

1. A unit for producing ammonia from a nitrogen-containing feedstock, comprising:
a nitrogen reduction unit comprising:
an inlet through which the feedstock is introduced into the unit,
a cathode comprising a porous active catalyst configured to be in fluid communication with the feedstock once introduced into the nitrogen reduction unit through the inlet, wherein the active catalyst reduces one or more nitrogen containing components in the feedstock to ammonia thereby providing an ammonia product stream, and
an outlet in fluid communication with the cathode and arranged downstream of the cathode for removal of ammonia from the nitrogen reduction unit;
an anode electrically connected to the cathode; and
aqueous electrolyte in fluid communication with the anode and cathode.

2. The nitrogen reduction unit of claim 1, wherein the cathode comprises a transition metal catalysts deposited on a porous conductive substrate.

3. The nitrogen reduction unit of claim 2, wherein the transition metal catalyst is electrodeposited onto the porous conductive substrate.

4. The nitrogen reduction unit of claim 2, wherein the porous conductive substrate is carbon paper.

5. (canceled)

6. The unit of claim 5, wherein the late transition metal catalyst is selected from iron, cobalt, nickel, copper, silver, gold, zinc, and a combination thereof.

7. The unit of claim 6, wherein the late transition metal catalyst is cobalt.

8. The unit of claim 7, wherein the cobalt is a cobalt oxide.

9. (canceled)

10. (canceled)

11. (canceled)

12. (canceled)

13. (canceled)

14. (canceled)

15. (canceled)

16. (canceled)

17. (canceled)

18. (canceled)

19. The unit of claim 1, further comprising a nitrogen oxidation unit upstream of the nitrogen reduction unit.

20. The unit of claim 19, wherein the nitrogen oxidation unit comprises:
an inlet through which an input gas containing nitrogen is introduced into the nitrogen oxidation unit;
the anode in contact with an anolyte, wherein the anode is configured to be in fluid communication with the input gas and the anode comprising a catalyst configured to oxidize nitrogen in the input gas to nitrate thereby providing a nitrate product stream; and
a nitrate product stream outlet in fluid communication with the anode and the nitrate reduction unit.

21. A nitrate reduction system for reducing nitrate in a feedstock to ammonia, comprising:
the unit of claim 1; and
an energy source configured to power the system.

22. The nitrate reduction system of claim 21, wherein the energy source comprises a wind energy source or a solar cell.

23. (canceled)

24. (canceled)

25. The nitrate reduction system of claim 21, further comprising an ammonia storage device.

26. (canceled)

27. A nitrate reduction system for reducing a nitrate in a feedstock to ammonia, comprising:
the unit of claim 19; and
an energy source configured to power the system.

28. The nitrate reduction system of claim 27, wherein the nitrate reduction system comprises an anion exchange membrane disposed between the nitrogen oxidation unit and the nitrate reduction unit,
wherein the anion exchange membrane is in fluid communication with the nitrogen oxidation unit and the nitrate reduction unit and the membrane facilitates diffusion and migration of nitrate from the nitrogen oxide unit to the nitrate reduction unit.

29. The nitrate reduction system of claim 27, wherein the nitrate reduction unit comprises a second inlet through which a second feedstock is introduced into the unit.

30. (canceled)

31. A nitrogen reduction unit for reducing nitrogen in an input gas to ammonia, comprising:
an inlet through which the input gas is introduced into the unit;
an anode;
a cathode comprising a porous active catalyst structure configured to be in fluid communication with the input gas, wherein the input gas is flowed perpendicular to the active catalysis and flows through the active catalyst, which reduces one or more nitrogen containing components in the input gas to ammonia thereby providing an ammonia product stream;
aqueous electrolyte in fluid communication with the anode and cathode; and
an outlet in fluid communication with the cathode and disposed downstream of the cathode.

32. The nitrogen reduction unit of claim 31, wherein the cathode comprises a transition metal catalysts deposited on a porous conductive substrate.

33. The nitrogen reduction unit of claim 32, wherein the transition metal catalyst is electrodeposited onto the porous conductive substrate.

34. (canceled)

35. (canceled)

36. The nitrogen reduction unit of claim 35, wherein the late transition metal catalyst is selected from iron, cobalt, nickel, copper, silver, gold, zinc, and a combination thereof.

37. (canceled)

38. (canceled)

39. The nitrogen reduction unit of claim 31, wherein the input gas comprises one or more nitrogen containing species selected from the group consisting of N₂, NO₃⁻, NO₂⁻, NOₓ, and a combination thereof.

40. (canceled)

41. (canceled)

42. (canceled)

43. (canceled)

44. (canceled)

45. A nitrogen reduction system for reducing nitrogen in an input gas to ammonia, comprising:
a nitrogen reduction unit of claim 31; and
an energy source configured to power the system.

46. A method for preparing ammonia using the unit of claim 1, comprising:
flowing the feedstock into the inlet, wherein upon contacting the active catalyst structure one or more nitrogen containing species present in the feedstock is reduced to ammonia to provide an ammonia product stream; and
flowing the ammonia product stream to the outlet.

47. (canceled)

48. (canceled)

49. (canceled)

50. A method for preparing ammonia using the unit of claim 19, comprising:
flowing the input gas containing nitrogen into the inlet of the nitrogen oxidation unit, wherein upon contacting the anode nitrogen is oxidized to nitrate thereby providing a nitrate product stream;
flowing the nitrate product stream to the nitrate reduction unit, wherein upon contacting the active catalyst structure nitrate is reduced to ammonia to provide an ammonia product stream; and
flowing the ammonia product stream to the outlet.

51. (canceled)

52. (canceled)

53. A method for preparing ammonia using the nitrogen reduction unit of claim 31, comprising:
flowing the input gas into the inlet, wherein upon contacting the active catalyst structure nitrogen is reduced to ammonia to provide an ammonia product stream; and
flowing the ammonia product stream to the outlet.
